(19) United States
(12) Patent Application Publication
(10) Pub. No.: US 2018/0082014 A1
(43) Pub. Date: Mar. 22, 2018

(54) BIOMARKER SEARCH DEVICE, BIOMARKER SEARCH METHOD, AND NON-TRANSITORY COMPUTER READABLE MEDIUM

(71) Applicant: KABUSHIKI KAISHA TOSHIBA, Tokyo (JP)

(72) Inventor: Topon PAUL, Kawasaki (JP)

(73) Assignee: KABUSHIKI KAISHA TOSHIBA, Tokyo (JP)

(21) Appl. No.: 15/462,304

(22) Filed: Mar. 17, 2017

(30) Foreign Application Priority Data
Sep. 21, 2016 (JP) 2016-184646

(51) Int. Cl. G06F 19/20

(52) U.S. Cl. CPC G06F 19/20

(57) ABSTRACT

A biomarker search device includes a gene variation group selector which generates combinations by combining biomolecule groups which hold interaction information, specifies gene variations associated with biomolecules included in the combinations based on mapping data calculates first evaluation values of the specified gene variations with respect to the biomolecules associated with the specified gene variations, respectively, based on influence data and specifies a typical gene variation group from the specified gene variations based on the first evaluation values, and an evaluator which calculates a second evaluation value with respect to the typical gene variation group based on gene variation data which holds genotype data of a case group afflicted with a specific disease and genotype data of a control group and selects the typical gene variation group from the typical gene variation groups based on the second evaluation values.

### CROSS REFERENCE TO RELATED APPLICATIONS

This application is based upon and claims the benefit of priority from Japanese Patent Application No. 2016-184646, filed on Sep. 21, 2016; the entire contents of which are incorporated herein by reference.

### FIELD

Embodiments described herein relate to a biomarker search device, a biomarker search method, and a non-transitory computer readable medium.

### BACKGROUND

In the body of human being, biomolecules such as proteins, nucleic acids, and genes exist, and these biomolecules change due to diseases, environmental factors, or the like. A gene is a part of genome DNA base sequence, and is a biomolecule having crypto information regarding a constitution or structure of protein when the protein is synthesized from DNA. A gene variation is a variation of genome base sequence of human being caused by an error during DNA replication, damage to DNA due to chemical substances or irradiation, or diseases, and includes SNP (Single Nucleotide Polymorphism), SNV (Single Nucleotide Variant), CNV (Copy Number Variation), and the like. A biotic indicator indicating a change caused in the body due to a specific disease is a biomarker, and in the field of genome, the SNP which reflects the presence/absence of the specific disease or a change in constitution, a gene, or a pathway is often used as the biomarker.

In order to search a SNP biomarker associated with a specific disease or quantitative trait from gene variation data, GWAS (Genome Wide Association Study) is widely used. The GWAS is a method of examining association between a specific disease or the like and the SNP, by using SNP data of a case group and a control group. Generally, in the GWAS, whether or not a frequency of gene variation of an allele of the case group is significantly higher than a frequency of gene variation of an allele of the control group in each SNP, is examined by using a statistical method, and the SNP is extracted as a biomarker.

However, 98% of human genome corresponds to non-coding DNA which does not code protein, and since positional information of SNP in genome information is not taken into consideration when searching the SNP biomarker, it is highly possible that the SNP selected in the conventional GWAS is positioned in a gene which is irrelevant to a disease, or an intergenic region which does not exert influence on synthesis of protein during translation. Specifically, in the conventional GWAS, there is a possibility of selecting a SNP which is not a factor of causing a disease, as a biomarker.

Further, there are an enormous number of gene variations, so that in the conventional GWAS system, a biomarker search is conducted by focusing attention on a single gene variation or a combination of two to four gene variations. Even if a single SNP is searched as a factor of causing the Mendelian genetic disease, in a case of a complicated genetic disease, not the SNP alone but the SNP in conjunction with another SNP causes the disease, so that almost all of genetic researches set comprehension of biological mechanism regarding development of disease, as a central target. In the conventional GWAS system, the selection of each SNP is independently conducted without taking interaction between SNPs into consideration, which leads to failure in detection of a relatively small effect due to a gene variation. As described above, it is difficult to give a biological meaning to the selected SNP.

### BRIEF DESCRIPTION OF THE DRAWINGS

FIG. 1 is a block diagram illustrating a functional configuration of a biomarker search device according to a first embodiment;

FIGS. 2A to 2D are diagrams each illustrating one example of gene variation data;

FIG. 3 is a diagram illustrating one example of biomolecule group data;

FIG. 4 is a diagram illustrating one example of mapping information;

FIG. 5 is a diagram illustrating one example of a genome region at a SNP position;

FIG. 6 is a diagram illustrating one example of biomarkers;

FIG. 7 is a flow chart illustrating one example of biomarker search processing;

FIG. 8 is a diagram illustrating one example of mapping between SNPs and biomolecules;

FIG. 9 is a diagram illustrating one example of typical gene variation groups in biomolecule group subsets;

FIG. 10 is a flow chart illustrating one example of biomolecule group subset selection processing;

FIG. 11 is a flow chart illustrating another example of the biomolecule group subset selection processing;

FIG. 12 is a flow chart illustrating one example of typical gene variation group selection using a genetic algorithm;

FIGS. 13A to 13C are diagrams each Illustrating one example of biomolecule group subsets and evaluation scores;

FIG. 14 is a diagram illustrating one example of processing in which crossing-over and mutation are applied to biomolecule group subsets obtained through elite selection;

FIG. 15 is a flow chart illustrating one example of typical gene variation group selection by using a threshold method;

FIG. 16 is a flow chart illustrating one example of typical gene variation group selection using a genetic algorithm;

FIGS. 17A to 17C are diagrams each illustrating one example of gene variation groups and evaluation scores;

FIG. 18 is a diagram illustrating one example of processing in which crossing-over and mutation are applied to gene variation groups obtained through elite selection;

FIG. 19 is a diagram illustrating one example of performing mapping of an unmapped gene variation to a biomolecule;

FIG. 20 is a block diagram illustrating a functional configuration of a biomarker search device according to a second embodiment;

FIG. 21 is a block diagram illustrating a functional configuration of a biomarker search device according to a third embodiment;

FIG. 22 is a block diagram illustrating a functional configuration of a biomarker search device according to a fourth embodiment;

FIG. 23 is a flow chart illustrating one example of processing of assigning a biomolecule to a biomolecule group; and

FIG. 24 is a diagram illustrating one example of hardware configuration.

### DETAILED DESCRIPTION

According to one embodiment, a biomarker search device includes a gene variation group selector which generates combinations by combining biomolecule groups which hold interaction information between biomolecules, specifies gene variations associated with biomolecules included in the combinations based on gene variation mapping data indicating biomolecules associated with gene variations, respectively, calculates first evaluation values of the specified gene variations with respect to the biomolecules associated with the specified gene variations, respectively, based on influence data representing a degree of influence given by the gene variations to the biomolecules and specifies a typical gene variation group from the specified gene variations based on the first evaluation values, and an evaluator which calculates a second evaluation value with respect to the typical gene variation group based on gene variation data which holds genotype data of a case group afflicted with a specific disease and genotype data of a control group and selects the typical gene variation group from the typical gene variation groups based on the second evaluation values.

Embodiments of the present invention will hereinafter be described with reference to the drawings.

### First Embodiment

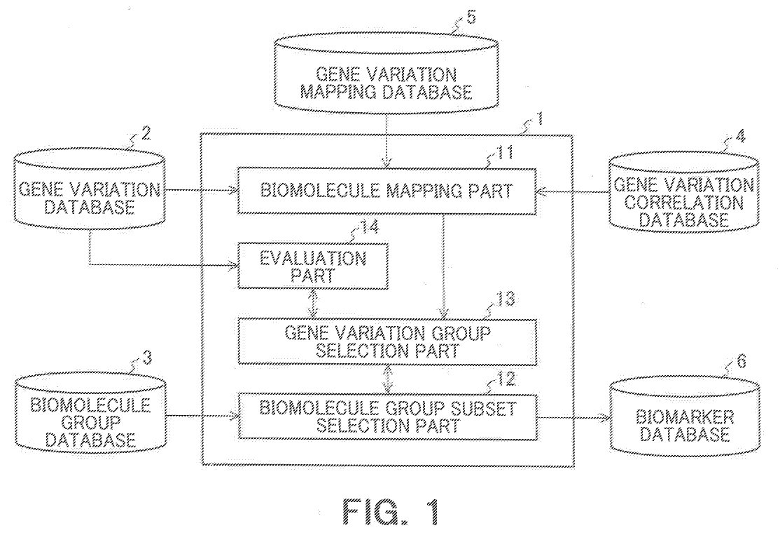

FIG. 1 is a block diagram illustrating a functional configuration of a biomarker search device according to the present embodiment. As illustrated in FIG. 1, the biomarker search device includes a biomarker search unit 1 a gene variation database 2, a biomolecule group database 3, a gene variation correlation database 4, a gene variation mapping database 5, and a biomarker database 6.

The biomarker search unit 1 includes a biomolecule mapping part 11, a biomolecule group subset selection part 12, a gene variation group selection part 13, and an evaluation part 14, and searches and outputs a gene variation, a biomolecule, a biomolecule group, and the like, as biomarkers.

The biomolecule mapping part 11 extracts, based on gene variation mapping data indicating a relationship between gene variations and biomolecules, a gene variation group (SNP: Single Nucleotide Polymorphism) associated with each biomolecule, and performs mapping of the extracted gene variation group to each biomolecule, to thereby generate biomolecule mapping data. A first gene group being a gene variation group to be extracted and mapped, corresponds to a gene variation group extracted from gene variation data which holds genotype data of a case group afflicted with a specific disease and genotype data of a control group, for example. Alternatively, it is also possible to extract a gene variation group itself included in the gene variation mapping data. Further, as will be described later; a gene variation which is not mapped to a biomolecule, is also subjected to mapping to a biomolecule, and a mapping destination is determined by using gene variation correlation data which holds correlation information between gene variations.

The biomolecule group subset selection part 12 selects, based on the biomolecule mapping data generated by the biomolecule mapping part 11 and biomolecule group data including a plurality of biomolecule groups, a biomolecule group subset from the plurality of biomolecule groups. The biomolecule group subset includes one or a plurality of biomolecule groups. Each of the plurality of biomolecule groups represents interaction information between biomolecules.

The gene variation group selection part 13 obtains a mapping score (first evaluation score) indicating a degree of influence or an evaluation value of a gene variation mapped to each biomolecule included in the biomolecule group subset selected by the biomolecule group subset selection part 12, with respect to the each biomolecule, by using the gene variation mapping data, and selects, based on this mapping score, typical gene variations (second gene variation group) from the aforementioned mapped gene variations. The mapping score is, for example, a score (gene variation score) indicating a functional influence exerted on the biomolecule by the gene variation. Note that although details regarding a method of selecting the biomolecule group subset with the use of the biomolecule group subset selection part 12 will be described later, there is a method of using the first evaluation score, as one of methods for the selection.

The evaluation part 14 calculates a second evaluation score, with respect to the second gene variation group selected by the gene variation group selection part 13, indicating association between the presence/absence of development of a specific disease and the second gene variation group, and performs evaluation on the second gene variation group as a biomarker; based on the second evaluation score. Concretely, by using the gene variation database 2, effectiveness of the second gene variation group as a biomarker for judging the presence/absence of development of a specific disease, is evaluated, It is possible to use, as the second evaluation value, a p value, a false discovery rate, an F-measure, and the like, for example. Finally, the second gene variation group having the highest second evaluation value, is obtained as a biomarker, for example. When the biomolecule group subset is generated by the biomolecule group subset selection part 12, the second evaluation value calculated by the evaluation part 14 may also be used, and in this case, it is also possible to design such that the second evaluation value is fed back to the biomolecule group subset selection part 12, to thereby repeatedly conduct the processing from the generation of the biomolecule group subset to the obtainment of the second evaluation value. Note that details of operations of the aforementioned respective parts will be described later.

The gene variation database 2 is a database holding the gene variation data. The gene variation data holds genotype data of a case group afflicted with a specific disease and genotype data of a control group. A genotype is a combination pattern of a plurality of bases (alleles) at a locus of a certain gene variation, and is determined by a DNA microarray technology, a next-generation sequencer, or the like. When types of alleles of a certain gene variation are G and T, genotypes of the gene variation include “GG”, “GT” and “TT”. There is a case where these genotypes are converted into integers for realizing high-speed calculation processing. For example, a major homozygous genotype, a heterozygous genotype, a minor homozygous genotype are converted into 2, 1, 0, or 0, 1, 2, respectively. When the genotypes are converted onto integers, mapping data regarding the conversion is required for performing mapping of gene variation data.

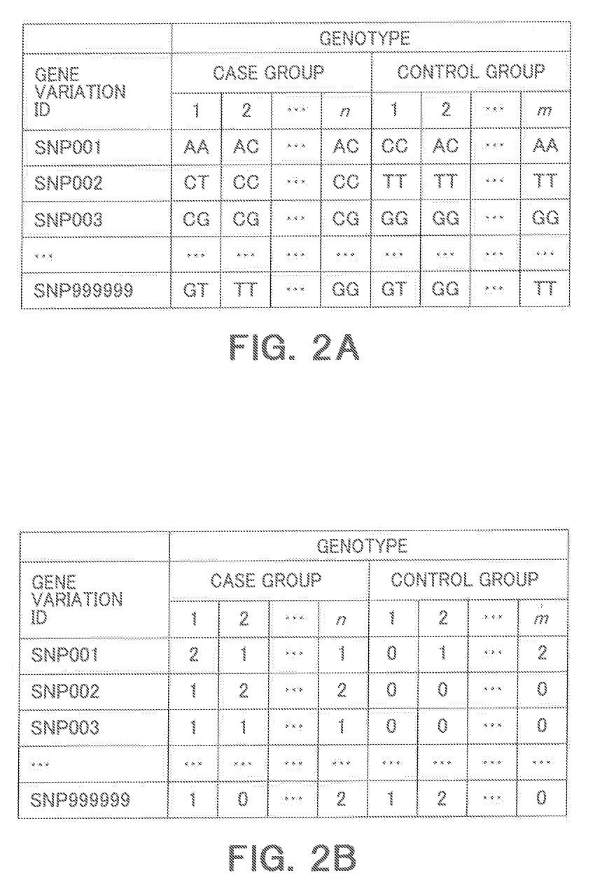

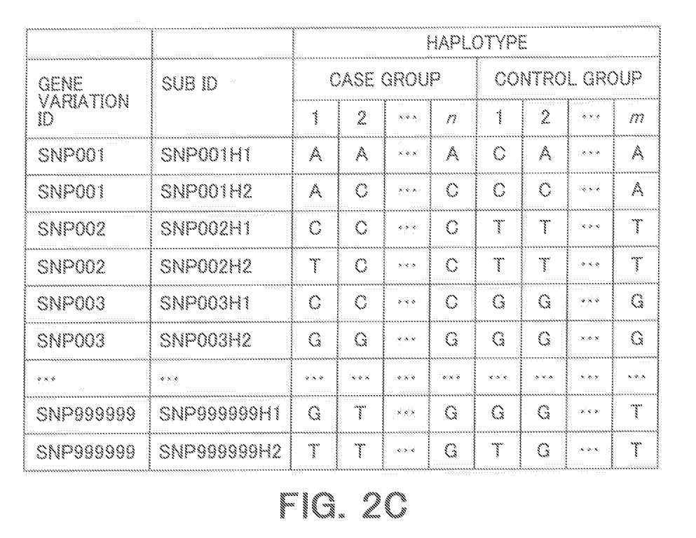

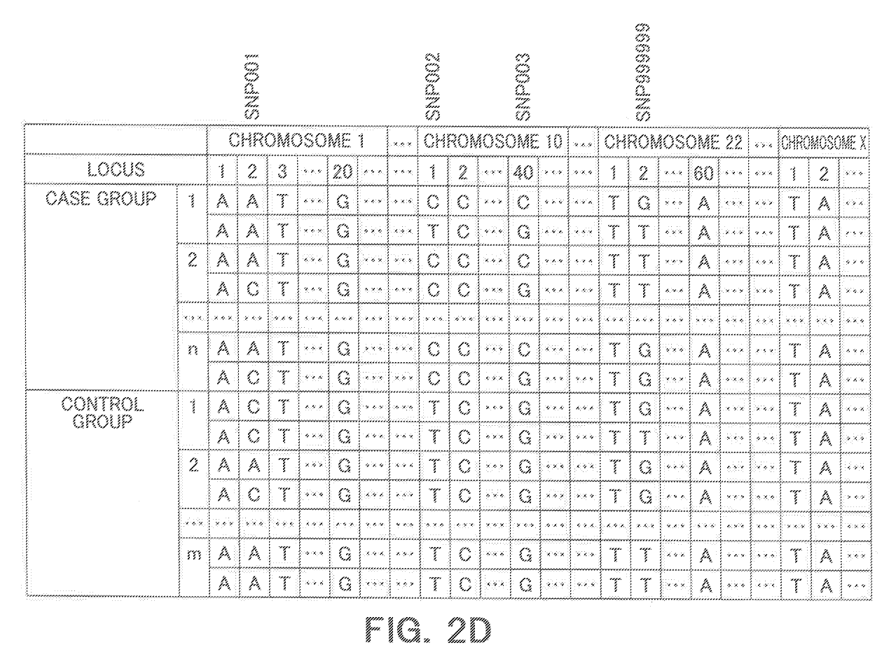

FIGS. 2A to 2D are diagrams each illustrating one example of the gene variation data. These pieces of data hold, in respective gene variations, IDs of the gene variations, genotypes of respective donated bodies of a case group and a control group, and the like. These diagrams illustrate a case where there are n pieces of data regarding the case group, and m pieces of data regarding the control group. Hereinafter, respective diagrams will be described, FIG. 2A is a diagram illustrating one example of the gene variation data, and FIG. 2B is a diagram illustrating one example of the gene variation data converted into integers.

FIG. 2A illustrates an example indicating a relationship between a gene variation ID and genotypes of respective samples with respect to the gene variation ID. For example, it is indicated that when the gene variation ID is SNP001, the genotype of a case ID1 is “AA”, the genotype of a case ID2 is “AC”, and the genotype of a case IDn is “AC”. Also in the control group, it is similarly indicated that the genotypes with respect to SNP001 are “CC” held by a control ID1, “AC” held by a control ID2, and “AA” held by a control IDm. As described above, FIG. 2A indicates the genotypes with respect to the gene variation ID, for each sample of the case group and the control group.

FIG. 2B illustrates an example indicating a relationship between the gene variation ID and the genotypes of the respective samples with respect to the gene variation ID, when the genotypes in FIG. 2A described above are converted into integers. In types of alleles A and C, the genotype “CC” is converted into 0, the genotype “AC” is converted into 1, and the genotype “AA” is converted into 2, and in the types of alleles G and T, the genotype “TT” is converted into 0, the genotype is converted into 1, and the genotype “GG” is converted into 2.

FIG. 2C illustrates a case where haplotype data is used instead of the genotypes, as the gene variation data. The haplotype (Haploid Genotype) indicates a haploid genotype, and is also referred to as a haplont. For example, a human being has a diploid having two sets of genomes in principle, and the haplotype indicates any one of combinations of alleles at respective loci of the genomes of the diploid. In FIG. 2C, SNP001H1 and SNP002H2 are allocated, as sub IDs, to the gene whose gene variation ID is SNP001. The haplotypes with respect to the SNP001H1 are “A” held by the case ID1, “A” held by the case ID2, “A” held by the case IDn, “C” held by the control ID1, “A” held by the control ID2, and “A” held by the control IDm. The haplotypes with respect to the other SNP002H2 are “A” held by the case ID1, “C” held by the case ID2, “C” held by the case IDn, “C” held by the control ID1, “C” held by the control ID2, and “A” held by the control IDm.

FIG. 2D illustrates a case where base sequence data generated by the next-generation sequencer is used instead of the genotypes, as the gene variation data. When the base sequence data is used, data other than that of the gene variation is eliminated in the preprocessing. When the base sequence data does not include the ID of gene variation, a location where variation occurs in the base sequence is determined, and by using a locus of that location, the ID of the gene variation at the location where the variation occurs, is extracted while referring to a reference gene variation database. As the reference gene variation database, dbSNP (Single Nucleotide Polymorphism Database) managed by NCBI (National Center for Biotechnology Information), Ensembl Variation database managed by European Bioinformatics Institute, USCS Genome Browser managed by University of California, Santa Cruz, and the like are used.

When the base sequence data of the case group afflicted with a specific disease, and the base sequence data of the control group exist as the gene variation data, the biomolecule mapping part 11 or the biomolecule group subset selection part 12 generates genotype data of the case group and genotype data of the control group from the pieces of base sequence data of the case group and the control group.

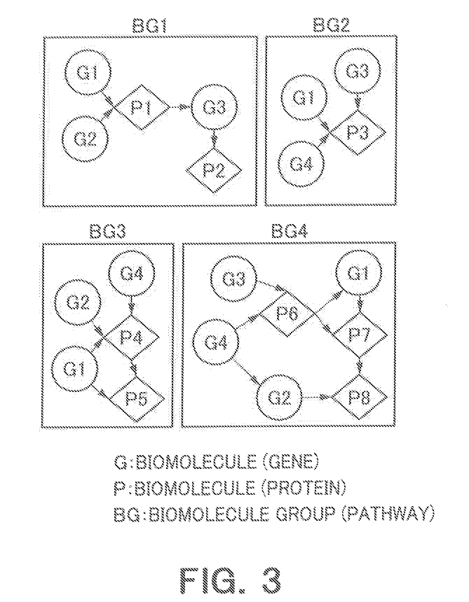

The biomolecule group database 3 holds the biomolecule group data being the interaction information between the biomolecules. FIG. 3 is a diagram illustrating one example of the biomolecule group data. The biomolecule group data is obtained from a reference biomolecule group database to be described below, and by performing preprocessing, a form such as one in FIG. 3 is obtained. The biomolecules indicate a gene G, protein P, and the like. For example, in a biomolecule group BG1, a gene G1 and a gene G2 play a role in generation of protein P1, and the protein P1 plays a role in generation of a gene G3. Further, the gene G3plays a role in generation of protein P2. The information obtained from the reference biomolecule group database is converted into the biomolecule group data indicating such pathways.

As the reference biomolecule group database, KEGG Pathway in Kyoto University, being an international benchmark database, Reactome Pathway Database in European Bioinformatics Institute, BioCarta in National Cancer Institute, STRING (Search Tool for the Retrieval of Interacting Genes/Proteins) database of protein-protein interactions, and the like, are used.

When the biomolecule group data does not exist, the biomolecule group subset selection part 12 generates biomolecule group data by setting each biomolecule to which a gene variation is mapped, as one biomolecule group.

The gene variation correlation database 4 is a database which provides gene variation correlation data regarding correlation information of gene conversion, which is, for example, linkage disequilibrium information or the like. For example, the gene variation correlation data corresponds to data which establishes associations between a gene variation ID and all gene variation IDs correlated with the gene variation. As databases and online tools regarding the gene variation correlation data, SNAP in Broad Institute introduced in “Johnson A D, et. al., SNAP: A web-based tool for identification and annotation of proxy SNPs using HapMap, Bioinformatics, 2008, 24 (24): 2938-2939”, dbSNP managed by National Center for Biotechnology Information, Ensembl Variation database managed by European Bioinformatics Institute, are used.

The gene variation mapping database 5 is a database or a tool which performs mapping of a gene variation to a biomolecule, and outputs, when an ID of a gene variation is input therein, mapping information including an ID of a biomolecule at which the gene variation is positioned or on which the gene variation exerts influence. As the mapping information, for example, information including a mapped biomolecule ID, a name of the biomolecule, a locus, a function, and at least one of a functional influence and a functional influence score, is output. The mapping information to be output is different depending on the database or the tool to be used.

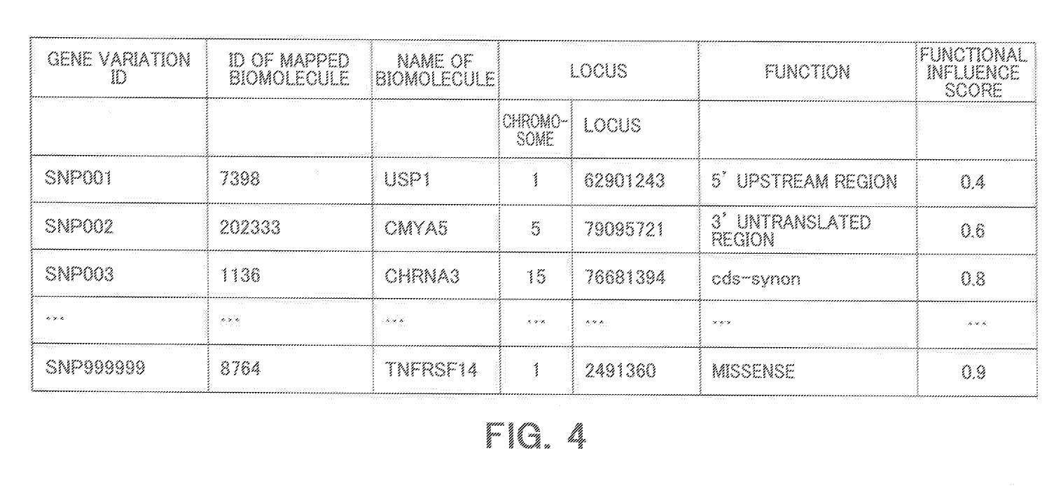

FIG. 4 is a diagram illustrating one example of an output result extracted from the gene variation mapping database 5. For example, with respect to the gene variation whose gene variation ID is SNP001, a mapped biomolecule ID is 7398, a name of the biomolecule is USP1, regarding a locus, a chromosome is 1 and a locus is 62901243, a function is 5′ upstream region, and a functional influence score is 0.4. By adopting the function and the functional influence as data, the possibility of extracting significant data is improved.

Depending on the data to be extracted, a plurality of mapping databases and/or tools are required. For example, a gene variation mapping tool A outputs the mapped biomolecule ID, the name of the biomolecule, the locus, and the function. On the other hand, a gene variation mapping tool B outputs the functional influence and the functional influence score. In this case, when the mapped biomolecule ID and the functional influence score are required, both of the gene variation mapping tool A and the gene variation mapping tool B are required. As illustrated in FIG. 4, in the present embodiment, the functional influence score is set to a gene variation score. Out of the data obtained by the gene variation mapping tool B or the gene variation mapping database 5, the data of a part including the gene variations, the biomolecules, and the scores, corresponds to one example of influence data representing a degree of influence exerted on the biomolecules by the gene variations.

As the gene variation mapping database, dbSNP managed by National Center for Biotechnology Information, Ensembl Variation database managed by European Bioinformatics Institute, USCS Genome Browser managed by University of California, Santa Cruz, and the like are used. Meanwhile, as a mapping tool for mapping a gene variation to a gene, SCAN (SNP and CNV Annotation Database), bioDBnet, biomaRt, Hyperlink Management System, SNPnexus, and the like, are used.

As a tool of analyzing the functional influence and the like of the gene variation, SNPNexus introduced in “DayemUllah A Z, et. al., SNPnexus: a web server for functional annotation of novel and publicly known genetic variants (2012 update), Nucleic Acids Research, 2012, 40 (W1): W65-70”, SPOT introduced in “Saccone S F, et. al., SPOT: a web-based tool for using biological database to prioritize SNPs after a genome-wide association study, Nucleic Acids Research, 2010, Vol. 38, Web Server Issue W201-W209”, F-SNP introduced in “Phil Hyonn Lee, et. al., An integrative scoring system for ranking SNPs by their potential deleterious effects. Bioinformatics (2009) 25 (8): 1048-1055.”, GenomePipe (GWAS Functional SNP Selection) in NIEHS, VEP (Variant Effect Predictor) of Ensembl, and the like are used.

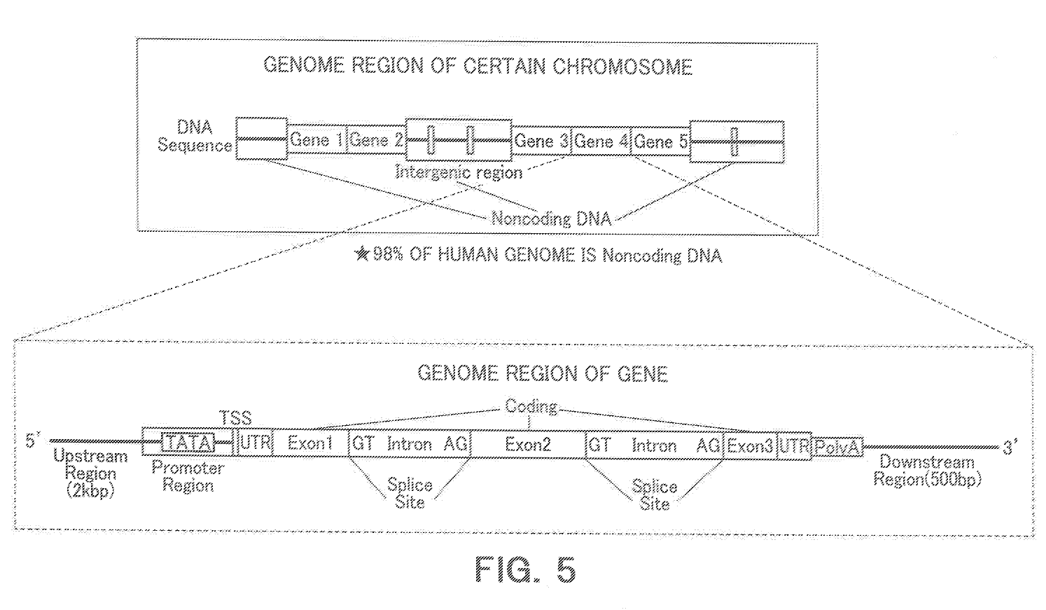

A function of the gene variation, for example, SNP is determined based on a position of the gene variation in a genome region. FIG. 5 is a diagram illustrating one example of a genome region at a SNP position. A human genome is mainly composed of a coding region to be translated into protein, and a noncoding region other than the coding region. About 98% of the human genome corresponds to noncoding DNA. A gene is a part which occupies a short region in DNA, and a large number of genes exist on a chromosome.

A noncoding region between genes on a chromosome corresponds to an intergenic region. One gene region is composed of a regulatory region, a 5′ untranslated region (5′ UTR), exons, Introns, a 3′ untranslated region (3′ UTR), and a poly A.

The regulatory region is composed of a promoter and an enhancer, and regulates a transcription initiation and a transcription amount. The untranslated regions are positioned at both sides of the coding region, and are regions which are not translated into proteins. The exons are an initiation codon and a termination codon positioned between the 5′ untranslated region (5′ UTR) and the 3′ untranslated region (3′ UTR), and are coding regions to be translated into proteins. The introns are untranslated regions, and are removed by splicing. The splicing is applied at splice sites positioned at an upper end and a lower end of the intron. The splice sites positioned on the 5′ side and the 3′ side of the gene sequence, are referred to as a donor site and an acceptor site, respectively. The poly A relates to stability of mRNA, and is a site which is important for nuclear exportation and translation.

Of the regions other than the above-described regions of the gene, a region up to 2000 base pairs from the regulatory region of the gene is a 5′ upstream region, and a region up to 500 base pairs from the poly A of the gene is a 3′ downstream region.

The functional Influence of SNP is different depending on the position of SNP in the genome region. The functional Influence of SNP includes the follows.

(1) Regulation of transcription by exerting influence on an activity of a transcription factor binding site (TRBS).

(2) Early termination of amino acid sequence (conversion into termination codon).

(3) Change in pattern or efficiency of splicing by causing division of the splice site or the enhancer (ESE) or a silencer (ESS) which binds exons.

(4) Change in protein structure or characteristic caused by a change in single amino acid or a frameshift of a protein coding region.

(5) Regulation regarding protein translation established by exerting influence on an activity of a microRNA (miRNA) binding site.

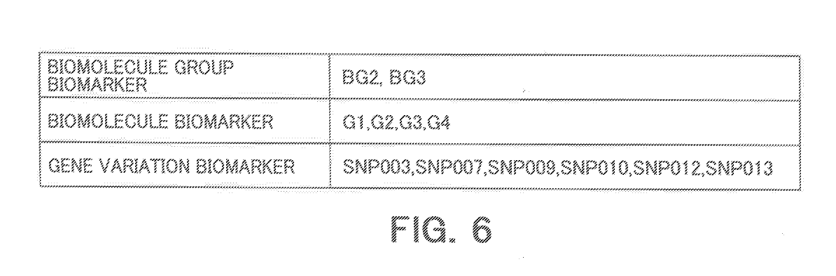

The biomarker database 6 records and holds the Information of biomarkers output by the biomarker search unit 1. FIG. 6 is a diagram illustrating one example of biomolecule group biomarker, biomolecule biomarker, and gene variation biomarker. For example, the biomolecule group biomarker includes a biomolecule group BG2 and a biomolecule group BG3, and the biomolecule biomarker includes a biomolecule G1, a biomolecule G2, a biomolecule G3, and a biomolecule G4, which form these biomolecule groups, Further, the gene variation biomarker includes a gene variation SNP003, a gene variation SNP007, a gene variation SNP008, a gene variation SNP010, a gene variation SNP012, and a gene variation SNP013, each having a high second evaluation score, out of gene variations configuring these biomolecules. These SNPs are extracted as a biomarker of focused disease.

Hereinafter, one example of processing regarding the biomarker search in the present embodiment will be described. First, as a prerequisite, the gene variation data, the biomolecule group data, the gene variation correlation data, and the gene variation mapping data from the universities, the research Institutions, the medical institutions, and the like cited above, are referred to, thereby previously inputting the pieces of data in the gene variation database 2, the biomolecule group database 3, the gene variation correlation database 4, and the gene variation mapping database 5, respectively. Alternatively, if the databases are not used, it is previously designed such that these pieces of data can be obtained from the aforementioned universities, research institutions, medical institutions, and the like, with the use of tools and the like.

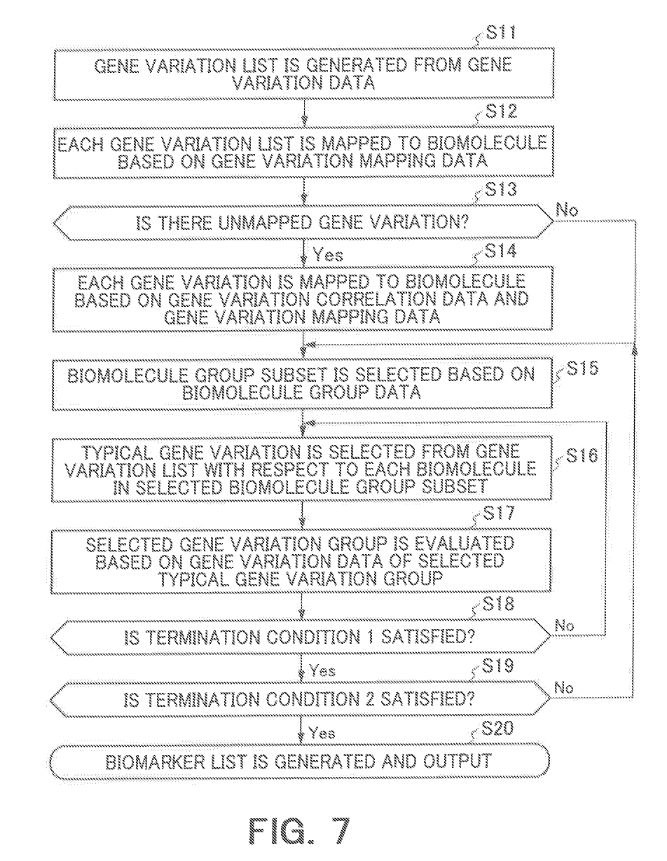

FIG. 7 is a flow chart Illustrating one example of processing of the biomarker search unit 1. As illustrated in FIG. 7, the biomolecule mapping part 11 first generates a gene variation list from the gene variation data (step S11). The gene variation list is, for example, a list including the gene variation SNP001, . . . , the gene variation SNP999999, illustrated in each of FIG. 2A to FIG. 2D.

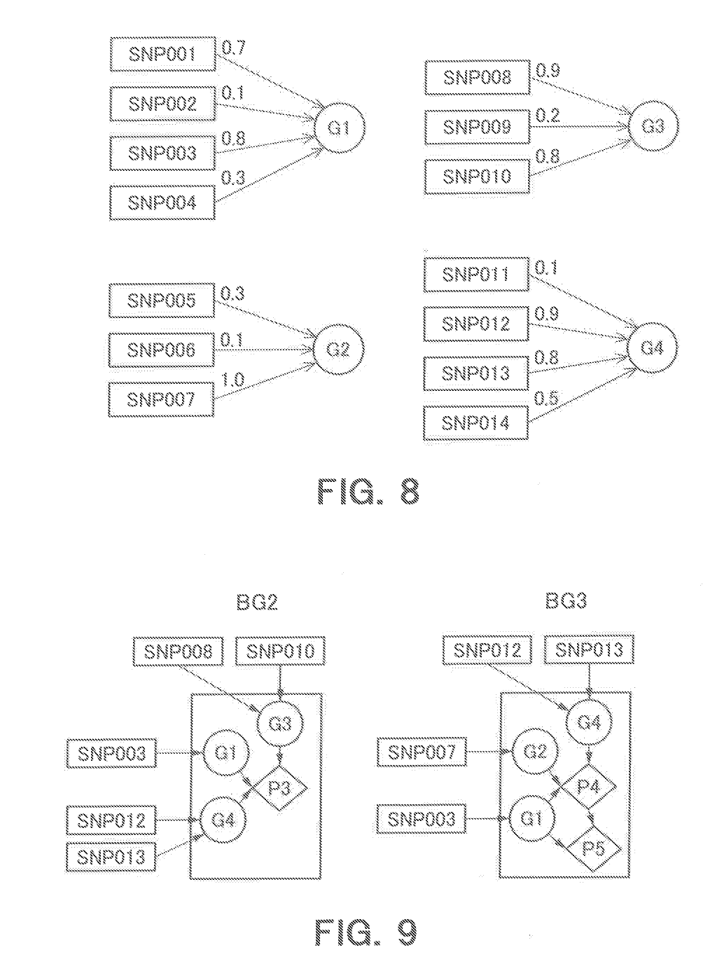

Next, the gene variation mapping part 11 performs, based on the gene variation mapping data held in the gene variation mapping database, mapping of respective gene variations in the gene variation list generated in step S11 to the biomolecules (step S12). FIG. 8 is a diagram illustrating one example of data obtained by mapping gene variations to biomolecules. As illustrated in FIG. 8, for example, the gene variation SNP001 to the gene variation SNP004 are mapped to the biomolecule G1. It is indicated that regarding the mapping scores applied from the respective gene variations to the biomolecule G1, the mapping score of the gene variation SNP001 is 0.7, the mapping score of the gene variation SNP002 is 0.1, the mapping score of the gene variation SNP003 is 0.8, and the mapping score of the gene variation SNP004 is 0.3. The mapping score is a value representing a quality at the time of mapping the gene variation to the biomolecule, and it is meant that the higher the mapping score, the higher the degree of contribution of the gene variation to the biomolecule. Regarding the other biomolecules, gene variations SNP005, SNP006, and SNP007, whose mapping scores are 0.3, 0.1, and 1.0, respectively, are mapped to the biomolecule G2, gene variations SNP008, SNP009, and SNP010, whose mapping scores are 0.9, 0.2, and 0.8, respectively, are mapped to the biomolecule G3, and gene variations SNP011, SNP012, SNP013, and SNP014, whose mapping scores are 0.1, 0.9, 0.8, and 0.5, respectively, are mapped to the biomolecule G4.

Referring back to FIG. 7, next, it is determined whether or not there is an unmapped gene variation (step S13). When there is the unmapped gene variation (step S13: Yes), each gene variation is mapped to the biomolecule based on the gene variation correlation data and the gene variation mapping data (step S14). Specifically, by using the gene variation correlation data, a gene variation having high correlation with the unmapped gene variation is extracted, and based on the fact that the extracted gene variation is mapped to which biomolecule in the gene variation mapping data, the unmapped gene variation is mapped to the biomolecule.

After processing in step S14 when there is the unmapped gene variation (step S13: Yes), or after the processing in step S13 when there is no unmapped gene variation (step S13: No), the biomolecule group subset selection part 12 selects a biomolecule group subset from the biomolecule group data (step S15). Hereinafter, it is set that, as one example, a biomolecule group subset BG2 and a biomolecule group subset BG3 are selected. Various methods can be applied for the selection, and at first, it is also possible to perform the selection randomly. Details of the method of selecting the biomolecule group subsets will be described later.

Next, the gene variation group selection part 13 selects a second gene variation group being a typical gene variation group, based on the mapping score with respect to the corresponding biomolecule, from the gene variation groups mapped to each biomolecule in the selected biomolecule group subsets (step S16). Next, the evaluation part 14 calculates a second evaluation score for evaluating the second gene variation group based on the gene variation data of the second gene variation group. The second evaluation score is a score of evaluating effectiveness of function of the second gene variation group as a biomarker, with respect to a specific disease. Details of these selection of the second gene variation group and evaluation of the second gene variation group will be described later.

FIG. 9 is a diagram illustrating one example of selecting the second gene variation group with respect to each biomolecule in the selected biomolecule group subset BG2 and the selected biomolecule group subset BG3. In the example of FIG. 9, the gene variation group selection part 13 sets a threshold value of a gene variation score to 0.8, and selects, out of the gene variations mapped to the biomolecules which exist in the selected biomolecule group subsets, all of the gene variations whose gene variation scores are 0.8 or more, as the second gene variation group. If the example of mapping illustrated in FIG. 8 is applied, the gene variation SNP003 is mapped to the biomolecule G1, the gene variation SNP007 is mapped to the biomolecule G2, the gene variation SNP008 and the gene variation SNP010 are mapped to the biomolecule G3, and the gene variations SNP012 and SNP013 are mapped to the biomolecule G4.

Referring back to FIG. 7, next, the evaluation part 14 evaluates the selected gene variation group by using gene variation data of the second gene variation group (step S17). This evaluation is performed based on indices (second evaluation scores) such as, for example, the p value being an index indicating whether or not the gene variation group is statistically significant, the FDR (False Discovery Rate) at which the gene variation is erroneously judged to be positive for a disease, and the F-measure determined by a precision ratio (ratio at which predicted data is correct) and a recall ratio (ratio at which actual expression data matches the predicted data). For example, in the example In FIG. 9 described above, the data of SNP003, SNP007, SNP008, SNP010, SNP012, and SNP013 being the gene variation group mapped to the respective biomolecules included in the biomolecule group subsets is obtained, and the p value, the false discovery rate, and the F-measure are calculated as the evaluation scores, to thereby evaluate the second gene variation group.

For example, a case of determining the above-described value in the SNP can be cited as follows. The genotypes of the case group and the control group regarding each SNP in the second gene variation group are extracted from the gene variation data. Concretely, as the genotypes of the case group, combinations of genotypes with respect to SNP003, SNP007, SNP008, SNP010, SNP012, and SNP013 are extracted from the gene variation data, as described above.

As one example, a combination of genotypes whose distribution is relatively high, in the extracted combinations of genotypes of the case group, when compared with the combination of genotypes of the control group (genotypes whose distribution is the highest, for example), is estimated as a combination of genotypes related to a specific disease. Alternatively, it is also possible to estimate all of the extracted combinations of genotypes of the case group, as the combinations of genotypes related to the specific disease.

After that, the FDR is calculated as the number of samples each having the aforementioned estimated combination of genotypes in the second gene variation group out of samples of the control group/the total number of samples of the control group.

The F-measure (F) is determined as F=2P*R/(P+R), by using the precision ratio (P) and the recall ratio (R). Here, when it is set such that TP indicates true positive (a probability at which the combination of genotypes in the samples of the case group matches the estimated combination of genotypes), FN indicates false negative (a probability at which the combination of genotypes in the samples of healthy subjects matches the estimated combination of genotypes of the healthy subjects), and FP indicates false positive (=FDR), the precision ratio P is represented by TP/(TP+FP), and the recall ratio R is represented by TP/(TP+FN).

Next, it is judged whether or not a termination condition 1 is satisfied (step S18). As the termination condition 1, for example, there can be cited a condition such that a minimum value of the gene variation score (first evaluation value) of the selected gene variation group is lower than a predetermined value, the number of times of evaluation reaches a previously set number of times of iteration, or there is no change in the second evaluation score of the gene variation group selected during the iteration performed twice in a row. When the termination condition 1 is not satisfied (step S18: No), the processing in step S16 and step S17 is repeated.

When the termination condition 1 is satisfied (step S18: Yes), next, it is judged whether or not a termination condition 2 is satisfied (step S19). As the termination condition 2, for example, there can be cited a condition such that the number of times of evaluation reaches the previously set number of times of iteration, or whether the evaluation is performed on all of the biomolecule groups. When the termination condition 2 is not satisfied (step S19: No), the processing returns to step S15 to select a new biomolecule group subset, and the evaluation in step S16 and step S17 is repeated.

When the termination condition 2 1s satisfied (step S19: Yes), the biomolecule group subset selection part 12 generates a biomarker list to output the list to the biomarker database 6 (step S20), and the processing is terminated. According to the example in FIG. 8 and FIG. 9 described above, the biomolecule group subset selection part 12 generates {BG2, BG3} as the biomolecule group biomarker, generates {G1, G2, G3, G4} as the biomolecule biomarker, generates {SNP003, SNP007, SNP008, SNP010, SNP012, SNP013} as the gene variation biomarker; and outputs these. Although depending on the processing method, as one example, the biomarker list is generated from the biomolecule group subsets and the second gene variation group when the termination condition 2 is satisfied.

The above corresponds to the flow of the entire processing performed by the biomarker search unit 1. Next, description will be made on an example of processing of biomolecule group subset selection performed by the biomolecule group subset selection part 12.

(First Method Regarding Biomolecule Group Selection)

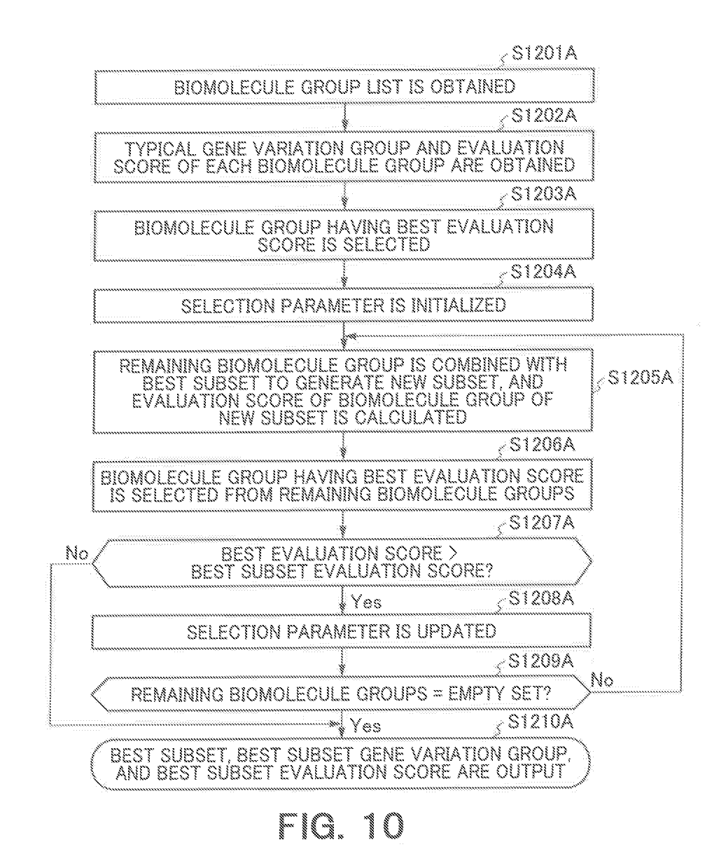

FIG. 10 is a flow chart illustrating one example of processing performed by the biomolecule group subset selection part 12 to select the biomolecule group subset. In the method illustrated in FIG. 10, the biomolecule group having the best evaluation score is selected from the biomolecule group data, and another biomolecule group is additionally selected in order to improve the evaluation score, to thereby select the biomolecule group subset. In the description hereinbelow, it is set that the biomolecule group subset selection part 12 performs the processing, unless otherwise stated.

First, the biomolecule group list is obtained from the biomolecule group database 3 (step S1201A). For example, the biomolecule group BG1 to the biomolecule group BG4 illustrated in FIG. 3, are obtained as the biomolecule group list.

Next, the typical gene variation group of each biomolecule group is obtained, and a subset evaluation score is calculated (step S1202A). The obtainment of the typical gene variation group is realized by obtaining the gene variation with high mapping score with respect to each biomolecule belonging to the biomolecule group, or by an optimization method based on the obtained gene variation with high mapping score, and details thereof will be described later (in a first method or a second method regarding gene variation group selection). The subset evaluation score mentioned here indicates, for example, a second evaluation score calculated by using the typical gene variation groups of all of the biomolecule groups belonging to the biomolecule group subset (the definition of the second evaluation score is similar to that of the second evaluation score determined with respect to the second gene variation group described above). Note that when calculating the evaluation score, it is also possible to design such that the calculation is performed, not by the biomolecule group subset selection part 12, but by the gene variation group selection part 13.

Next, the biomolecule group having the best subset evaluation score is selected (step S1203A). After the biomolecule group is selected, a selection parameter is initialized (step S1204A). Hereinafter, description will be made by assuming that there are BG1, BG2, BG3, and BG4, as the biomolecule groups, as one example.

The selection parameter is initialized through the following processing, for example.

(1) The selected biomolecule group is set as the best subset. In the above-described example, BG2 is set.

(2) The typical gene variation group of the selected biomolecule group is set as the best subset gene variation group. In the above-described example, SNP003, SNP008, SNP010, SNP012, and SNP013 are set.

(3) The subset evaluation score of the selected biomolecule group is set as the best subset evaluation score. In the above-described example, the evaluation score of BG2 is set.

(4) As the remaining biomolecule groups, a set as a result of subtracting the selected biomolecule group from all of the biomolecule groups. is set. In the above-described example, BG1, BG3, and BG4 are set.

Next, each of the remaining biomolecule groups and the best subset are combined to generate a new subset, and an evaluation score of the biomolecule group of the new subset is calculated by using the gene variation group selection part 13 (step S1205A). In the above-described example, the subset evaluation score in a case where each of BG1, BG3, and BG4 being elements of the set of the remaining biomolecule subsets, and BG2, are combined to generate a new subset, and the biomolecule groups of each of these new subsets are set as one biomolecule group, is calculated.

Next, the biomolecule group which forms the subset with respect to which the best subset evaluation score is calculated, out of the new subsets generated in step S1205A, is selected (step S1206A). In the above-described example, when the evaluation value of the subset formed by combining BG2 and BG3 is higher than the evaluation value of the subset formed by combining BG2and BG1 and the evaluation value of the subset formed by combining BG2 and BG4, for example, BG3 is selected from the remaining biomolecule groups. Subsequently, BG2 and BG3 are combined to generate a new subset.

Next, the subset evaluation score of the new subset and the best subset evaluation score are compared (step S1207A). In the above-described example, the subset evaluation score of BG2 and the subset evaluation score of the new subset formed by combining BG2 and BG3, are compared.

When the evaluation score of the new subset is higher than the best subset evaluation score (S1207A: Yes), the selection parameter is updated (S1208A). The selection parameter is updated through the following processing.

(1) As the best subset, a sum of sets of the best subset and the selected biomolecule group is set. In the above-described example, the subset formed by combining BG2 and BG3 is set, instead of BG2.

(2) As the best subset gene variation group, a sum of sets of the best subset gene variation group and the typical gene variation group of the selected biomolecule group is set. In the above-described example, SNP003, SNP007, SNP008, SNP010, SNP012, and SNP013 are set.

(3) As the best subset evaluation score, the subset evaluation score of the new subset is set. In the above-described example, the subset evaluation score of the subset formed by combining BG2 and BG3 is set.

(4) As the remaining biomolecule groups, a set as a result of subtracting the selected biomolecule group from the remaining biomolecule groups is set. In the above-described example, BG1and BG4, as a result of removing BG3 from BG1, BG3, and BG4, are set.

On the other hand, when the subset evaluation score of the new subset is not higher than the best subset evaluation score (S1207A: No), the processing proceeds to step S1210A.

Next, it is judged whether or not the remaining biomolecule groups correspond to an empty set (step S1209A). If stated differently, it is judged whether or not the above-described processing is performed on all of the biomolecule groups included in the remaining biomolecule groups in the initial state. When the remaining biomolecule groups do not correspond to the empty set (step S1209A: No), the processing returns to step S1205A. In the above-described example, BG1 and BG4 are included in the remaining biomolecule groups, so that the processing is repeated until when the processing on the combination of BG1 and BG4 is finished.

On the other hand, when the remaining biomolecule groups correspond to the empty set (step S1209A: Yes), the best subset, the best subset gene variation group, and the best subset evaluation score are output (step A1210A), and the processing is terminated. As described above, the biomolecule group subset having the best evaluation score, and the second gene variation group being the typical gene variation group of the biomolecule group subset, are selected.

Note that in the above description, it is set that the best subset is one having the best subset evaluation score, but, it is not limited to this, and it is also possible that a predetermined condition, for example, a threshold value is set, and a subset whose evaluation score is higher than the threshold value is set as the best subset. Further, it is also possible to design such that the above-described processing is performed on ail of the biomolecule groups satisfying such a predetermined condition, and the best one is selected finally. Further, it is also possible to design such that the processing above is conducted by extracting a subset which is not the best one in a stochastic manner, for example, by using a Monte Carlo method or the like.

(Second Method Regarding Biomolecule Group Selection)

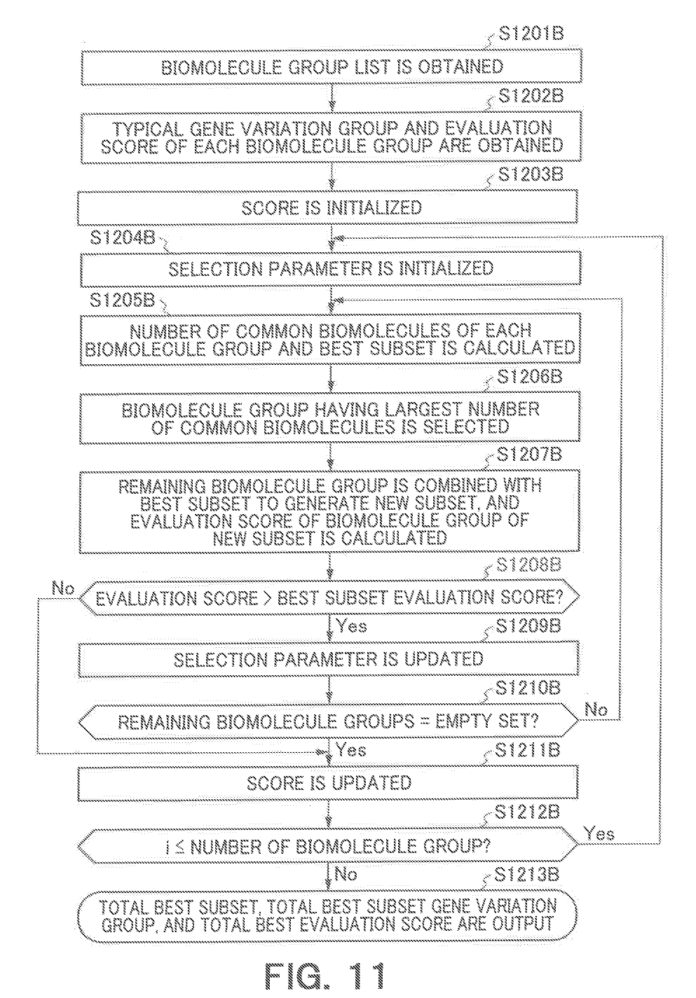

FIG. 11 is a flow chart illustrating another example of the processing performed by the biomolecule group subset selection part 12 to select the biomolecule group subset. In the method Illustrated in FIG. 11, based on a number of biomolecules which are common to those in each biomolecule group in the biomolecule group data, another biomolecule group is additionally selected to generate a biomolecule group subset, to thereby select a biomolecule group subset having the best evaluation score. Hereinafter, description will be made in detail by using an example similar to that of the above description.

First, the biomolecule group list is obtained from the biomolecule group database 3 (step S1201B). For example, the biomolecule group BG1 to the biomolecule group BG4 illustrated in FIG. 3, are obtained as the biomolecule group list.

Next, the typical gene variation group of each biomolecule group is obtained, and the subset evaluation score thereof is calculated (step S1202B). As the subset evaluation score, the second evaluation score is used, for example, in a similar manner to the above-described case. Note that when calculating the subset evaluation score, it is also possible to design such that the calculation is performed, not by the biomolecule group subset selection part 12, but by the gene variation group selection part 13.

Next, a variable and a score are initialized (step S1203B). The variable and the score are Initialized through the following processing, for example.

(1) An iteration variable i is set to 1.

(2) A total best subset is set to an empty set.

(3) A total best subset gene variation group is set to an empty set.

(4) A total best evaluation score is set to 0.

Next, the selection parameter is initialized (step S1204B). The selection parameter is initialized through the following processing, for example.

(1) As the best subset, an i-th biomolecule group is set. In the above-described example, BG1 is set as the best subset, for example.

(2) As the best subset gene variation group, a typical gene variation group of the i-th biomolecule group is set. In the above-described example, SNP003, SNP007, SNP008, and SNP010, being the typical gene variation group of BG1, are set.

(3) As the best subset evaluation score, a subset evaluation score of the i-th biomolecule group is set. In the above-described example, the subset evaluation score of BG1 is set.

(4) As the remaining biomolecule groups, a set as a result of removing the i-th biomolecule group from all of the biomolecule groups is set. In the above-described example, BG2, BG3, and BG4 are set.

Next, the number of biomolecules which are common to the biomolecules forming the best subset in each of the remaining biomolecule groups is calculated (step S1205B). In the above-described example, the biomolecules forming BG1 are G1, G2, and G3, so that the number of biomolecules which are common to these biomolecules is calculated for each of BG2, BG3, and BG4, being each of the remaining biomolecule groups. The number for BG2 is calculated as two, the number for BG3 is calculated as two, and the number for BG4 is calculated as three.

Next, from the remaining respective biomolecule groups, the biomolecule group having the largest number of biomolecules which are common to the biomolecules forming the best biomolecule subset is selected (step S1206B). In the above-described example, the biomolecule group having the largest number of biomolecules which are common to those forming BG1 is BG4, so that BG4 is selected.

Next, the best subset and the selected biomolecule group are combined to generate a new subset, and by using the gene variation group selection part 13, the subset evaluation score of the biomolecule group of the new subset is calculated (step S1207B). As the subset evaluation score, the second evaluation score such as the p value, the false discovery rate, and the F-measure, are used, similarly to the above description. In the above-described example, BG1 and BG4 are combined to generate a new subset, and the subset evaluation score of the generated new subset is calculated.

Next, the evaluation score of the new subset and the subset evaluation score of the best subset are compared (step S1208B). In the above-described example, the subset evaluation score of the new subset formed by combining BG1 and BG4, and the subset evaluation score of BG1 being the best subset, are compared. When the evaluation score of the new subset is higher than the subset evaluation score of the best subset (step S1208B: Yes), the processing proceeds to step S1209B, and if not (step S1208B; No), the processing proceeds to step S1211B.

When the evaluation score of the new subset is higher than the subset evaluation score of the best subset, the selection parameter is updated (step S1209B). The selection parameter is updated through the following processing, for example.

(1) As the best subset, a sum of sets of the best subset and the selected biomolecule group is set. In the above-described example, the biomolecule group subset formed by combining BG1and BG4 is set.

(2) As the best subset gene variation group, a sum of sets of the best subset gene variation group and the typical gene variation group of the selected biomolecule group is set. In the above-described example, SNP003, SNP0007, SNP008, SNP010, SNP012, and SNP013 are set, for example,

(3) As the best subset evaluation score, the calculated subset evaluation score of the biomolecule group of the new subset is set. In the above-described example, the subset evaluation score of the biomolecule group subset formed by combining BG1 and BG4 is set.

(4) As the remaining biomolecule groups, a set as a result of subtracting the selected biomolecule group from the remaining biomolecule groups is set. In the above-described example, BG2and BG3 are set.

Next, it is judged whether or not the remaining biomolecule groups correspond to an empty set (step S1210B). In other words, it is judged whether or not the above-described processing is performed on ail of the biomolecule groups included in the remaining biomolecule groups in the initial state. When the remaining biomolecule groups do not correspond to the empty set (step S1210B: No), the processing returns to step S1205B. In the above-described example, BG2 and BG3 are Included in the remaining biomolecule groups, so that the processing is repeated until when the processing on the combination of BG2 and BG3 is finished.

On the other hand, when the remaining biomolecule groups correspond to the empty set (step S1210B: Yes), and when the evaluation score of the new subset is higher than the subset evaluation score of the best subset (step S1208B: Yes), the variable and the score are updated (step S1211B), The variable and the score are updated through the following processing, for example.

(1) The iteration variable i is incremented.

(2) As the total best subset, the best subset is set. In the above-described example, the biomolecule group subset formed by combining BG1 and BG4 is set.

(3) As the total best subset gene variation group, the best subset gene variation group is set. In the above-described example, SNP003, SNP007, SNP008, SNP010, SNP012, and SNP013 are set.

(4) As the total best evaluation score, the subset evaluation score of the best subset is set. In the above-described example, the subset evaluation score of the biomolecule group subset formed by combining BG1 and BG4 is set.

Next, it is judged whether or not the Iteration variable i is smaller than the number of biomolecule groups (step S1212B), When the iteration variable i is smaller than the number of biomolecule groups (step S1212B: No), the evaluation regarding all of the biomolecule groups is not yet finished, so that the processing returns to step S1204B to repeat the processing. On the other hand, when the iteration variable i is equal to or larger than the number of biomolecule groups (step S1212B: Yes), there is created a state where the evaluation regarding all of the biomolecule groups is finished, so that the processing proceeds to the next step.

Next, the total best subset, the total best subset gene variation group, and the total best evaluation score are output (step S1213B), and the processing is terminated. As described above, the biomolecule group subset having the best evaluation score, and the second gene variation group being the typical gene variation group of the biomolecule group subset, are selected. Note that similarly to the above-described first method, whether or not the best one or the one with the largest number is selected, is not limited to the way of the second method, and it is also possible to perform the selection in accordance with a predetermined condition.

(Third Method Regarding Biomolecule Group Selection)

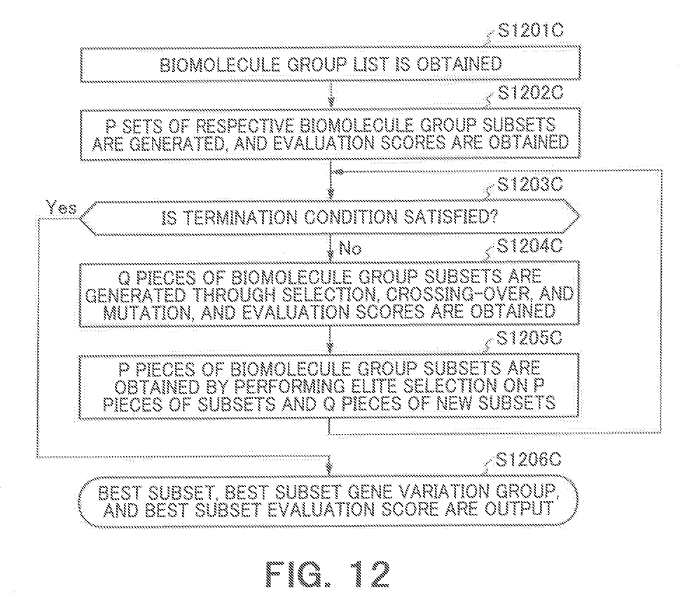

FIG. 12 is a flow chart illustrating still another example of the processing performed by the biomolecule group subset selection part 12 to select the biomolecule group subset. In the method illustrated in FIG. 12, a genetic algorithm (GA) is used to select the biomolecule group subset. Hereinafter, description will be made by using an example similar to that of the above description.

First, the biomolecule group list is obtained from the biomolecule group database 3 (step S1201C). For example, the biomolecule group BG1 to the biomolecule group BG4 illustrated in FIG. 3, are obtained as the biomolecule group list.

Next, one or more biomolecule groups are randomly selected from the biomolecule group list, to generate P sets of the biomolecule group subsets, the typical gene variation group of each biomolecule group subset is selected, and the subset evaluation score of the typical gene variation group is calculated by using the evaluation part 14 (step S1202C). Note that when calculating the subset evaluation score, it is also possible to design such that the calculation is performed, not by the biomolecule group subset selection part 12, but by the gene variation group selection part 13. In a similar manner to the above description, the second evaluation score is used as the subset evaluation score mentioned here, for example.

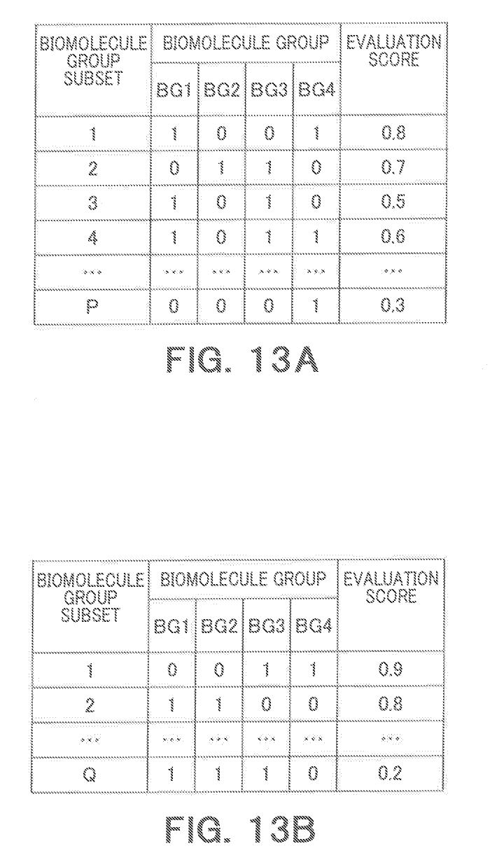

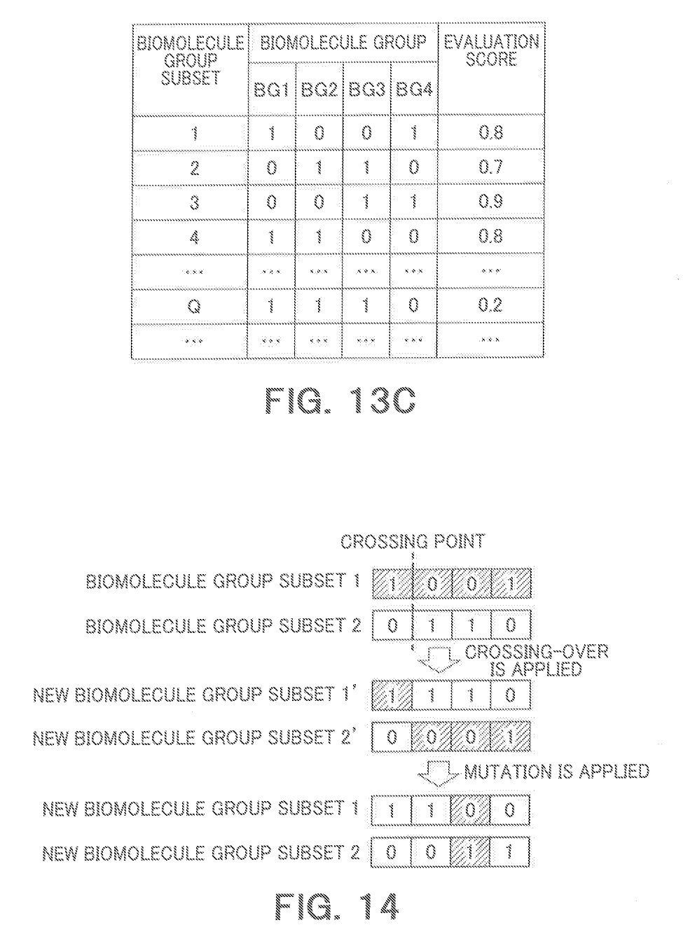

FIG. 13A is a diagram Illustrating one example of a set of the biomolecule group subsets, and the subset evaluation scores. Hereinafter, in FIG. 13A to FIG. 13C, and FIG. 14, in the Table indicates that the biomolecule group is selected, and “0” indicates that the biomolecule group is not selected. As illustrated in FIG. 13A, for example, a biomolecule group subset 1 is a subset formed of BG1 and BG4, and has the subset evaluation score of 0.8. In a similar manner, a biomolecule group subset 2 is a subset formed of BG2 and BG3, and has the subset evaluation score of 0.7, The P pieces of such subsets are generated.

Next, it is judged whether or not a termination condition is satisfied (step S1203C). The termination condition is, for example, a condition such that the subset evaluation score is equal to or more than a predetermined value, the processing is performed the number of times of Iteration which is previously set, or there is no change in the subset evaluation score of the best biomolecule group subset during the continuous iteration processing. When the termination condition is satisfied (step S1203C: Yes), the best subset, the best subset gene variation group, and the best subset evaluation score are output (step S1206C), and the processing is terminated.

On the other hand, when the termination condition is not satisfied (step S1203C: No), the processing proceeds to one of genetic algorithm. Specifically, selection, crossing-over, and mutation are applied Q/2 times, to generate Q pieces of new biomolecule group subsets, the gene variation group selection part 13 is used to select the typical gene variation group of each biomolecule group subset, and the evaluation part 14 is used to calculate the subset evaluation score of the typical gene variation group (step S1204C). In each of the iterations, two biomolecule group subsets are selected from the set of the biomolecule group subsets based on the subset evaluation scores, and the operation of crossing-over and mutation is applied to the selected biomolecule group subsets based on a previously set probability, FIG. 13B is a diagram illustrating Q pieces of biomolecule group subsets which are generated after performing the processing above.

FIG. 14 is a diagram illustrating one example regarding the processing above. For example, in the set of the biomolecule group subsets illustrated in FIG. 13A, the subset evaluation scores of the biomolecule group subset 1 and the biomolecule group subset 2 are good, so that the two biomolecule group subsets are selected, and the crossing-over and the mutation are applied to the biomolecule group subsets.

In FIG. 14, the biomolecules of the biomolecule group subsets 1 and 2 are crossed over, by setting a position between G1 and G2 as a crossing point. As new biomolecule groups subsets, a biomolecule group subset 1′ and a biomolecule group subset 2′ are generated. In addition to that, by applying the mutation to a part of G3 in each of these subsets, a new biomolecule group subset 1 and a new biomolecule group subset 2 illustrated in the drawing are generated. Such processing is repeated Q/2 times, to generate Q pieces of new biomolecule group subsets. Note that the number of crossing point is not limited to one but may be plural numbers, and the mutation is not limited to one which occurs In one biomolecule group, but may be one which occurs in the plurality of biomolecule groups or one which occurs randomly in eight pieces of biomolecule groups of the two biomolecule group subsets after being subjected to the crossing-over. Further, the above is not limited to the case where the subsets with good subset evaluation scores are crossed over, but, it is also possible to design such that the subsets are selected regardless of their subset evaluation scores or the subsets with lower subset evaluation scores are selected at a predetermined probability.

Referring back to FIG. 12, next, the P pieces of subsets (FIG. 13A) and the Q pieces of subsets (FIG. 13B) are used to perform elite selection processing of genetic algorithm, thereby selecting P pieces of biomolecule group subsets to generate a set of biomolecule group subsets for the next iteration (step S1205C). FIG. 13C is a diagram illustrating biomolecule group subsets newly selected by the elite selection. As illustrated In FIG. 13C, two subsets with good evaluation values are selected from the original subsets (FIG. 13A), and the rest of the subsets are selected from the newly generated subsets (FIG. 13B). Each of P and Q is a predetermined Integer, and P indicates 500, and Q indicates 498, for example. When the number of obtained biomolecules is four, a value of the integer becomes excessive, but, since the combination of subsets is increased by an exponentiation of 2, in the case where the biomolecules whose number is 10 or more are obtained, this leads to reduction in analysis time. Note that these parameters regarding the genetic algorithm can be freely changed by design.

The above is the description regarding the selection of the biomolecule group subset. Next, description will be made on processing in which the gene variations are selected from these selected biomolecule group subsets. The gene variation group selection part 13 selects the second gene variation group being the typical gene variation group of the biomolecule which exists in the biomolecule group subset selected by the biomolecule group subset selection part 12. Pluralities of gene variations are mapped to each biomolecule, so that the selection of the second gene variation group involves a combinational optimization problem. Note that hereinbelow, it is set that the gene variation group selection part 13 performs the processing, unless otherwise stated.

(First Method Regarding Gene Variation Group Selection)

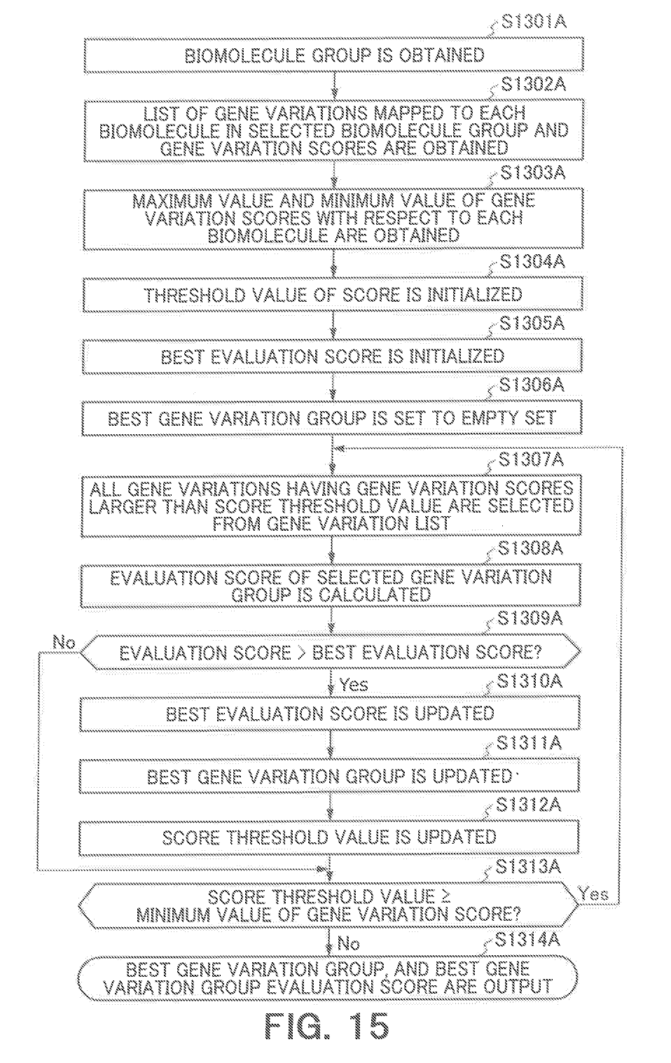

FIG. 15 is a flow chart illustrating a flow of processing of the second gene variation group selection using a threshold method. First, the biomolecule group which exists in the biomolecule group subset selected by the biomolecule group subset selection part 12 is obtained (step S1301A). This processing corresponds to processing of obtaining the biomolecule group subset selected through the processing as described above.

Next, a list of gene variations mapped by the biomolecule mapping part 11 to each biomolecule of the obtained biomolecule group subset, and gene variation scores being the first evaluation scores of the gene variations, are obtained (step S1302). Here, when the biomolecule mapping part 11 does not give the first evaluation score to each gene variation, the first evaluation score is set based on the function of gene variation. For example, scores when the gene variation functions in coding nonsense, coding missense, intron splice site, regulation of transcription, transcription factor binding site, cds-synon, intron, 5′ upstream region, 3″ downstream region, 5′ untranslated region, 3′ untranslated region, and gene-to-gene, are previously set to 1.0, 0.9, 0.8, 0.8, 0.8, 0.6, 0.5, 0.1, 0.1, 0.1, 0.1, and 0.2, respectively.

Next, a maximum value and a minimum value of the first evaluation scores are obtained (step S1303A). Subsequently, a threshold value of the score is initialized to the maximum value of the first evaluation score (step S1304A). Specifically, the score threshold value is set to be equal to the maximum value of the first evaluation score. In addition, the best evaluation score is initialized (step S1305A). By setting the best evaluation score to 0 (lowest value), the best evaluation score is initialized. Further, an empty set is set to the best gene variation group (step S1306A). After Initialization as described above, the processing proceeds to selection processing of the gene variation.

First, all gene variations each having the first evaluation score larger than the score threshold value, are selected from the gene variation list (step S1307A). Specifically, in the initial state, the gene variation whose first evaluation score is the largest value is selected.

Next, the evaluation part 14 is used to calculate an evaluation score of the selected gene variation group (step S1308A). As the evaluation score, the second evaluation score is used, for example.

Next, it is judged whether or not the second evaluation score is better than the best evaluation score (step S1309A), In the initial state, the best evaluation score is 0 (lowest value), so that the evaluation value calculated in step S1308A is judged to be better than the best evaluation score.

When the second evaluation score is not better than the best evaluation score (step S1309A: No), the processing proceeds to step S1312A. On the other hand, when the second evaluation score is better than the best evaluation score (step S1309A: Yes), the best evaluation score is updated (step S1310A). Specifically, the best evaluation score is set to be equal to the calculates second evaluation score.

Next, the best gene variation group is updated (step S1311A). The gene variation group having the best evaluation score updated in step S1310A is set to the best gene variation group.

Next, the score threshold value is updated (step S1312A). By using a previously set predetermined value Δ, the score threshold value is updated as the score threshold value=the score threshold value−Δ. Δ is a deduction of the score threshold value, and when the maximum value and the minimum value of the first evaluation scores are 1.0 and 0.0, respectively, Δ is set to 0.1, 0.05, 0.0, or the like. Further, Δ may take another value between the maximum value and the minimum value. As the value becomes smaller, accuracy of the selection becomes high but a processing time of the selection increases and as the value becomes larger, the processing time reduces but the accuracy of the selection deteriorates. Δ is determined by taking these into consideration. Further, although Δ is set to the predetermined value, there is no need to keep a constant value, and, for example, it is also possible to design such that Δ is gradually reduced to a smaller value by random number control, as in the Monte Carlo method, for example.

Next, it is judged whether or not the score threshold value is equal to or larger than the minimum value of the first evaluation score (step S1313A). When the score threshold value is equal to or larger than the minimum value of the first evaluation score (step S1313A: Yes), the processing returns to step S1307A, and the above-described processing is repeated.

On the other hand, when the score threshold value is smaller than the minimum value of the first evaluation score (step S1313A: No), all gene variations are selected in step S1307, and even if the processing is iterated, only the same result can be obtained, so that the best gene variation group and the best evaluation score are output (step S1314A), and the processing is terminated. The output best gene variation group is the second gene variation group being the typical gene variation group.

(Second Method Regarding Gene Variation Group Selection)

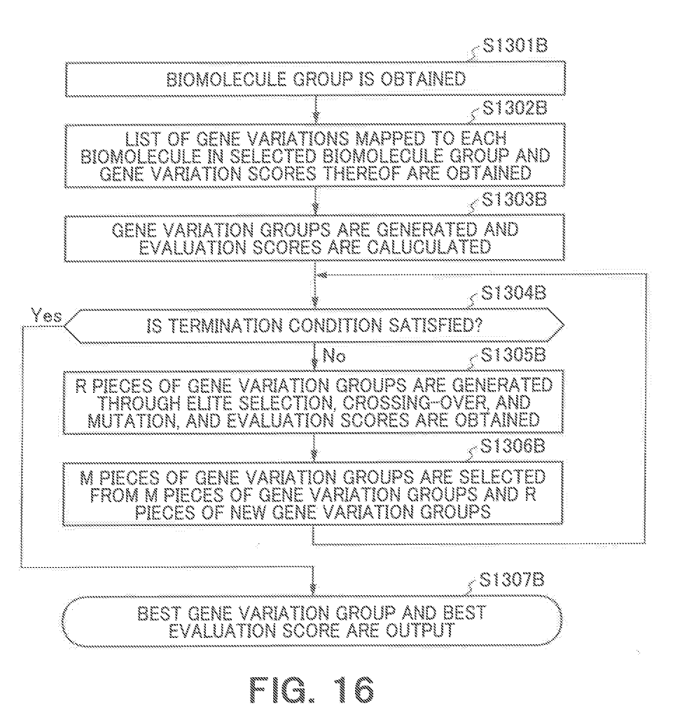

FIG. 16 is a flow chart Illustrating the processing of selection of the second gene variation group using a genetic algorithm. It is tried to use the genetic algorithm regarding the selection of the second gene variation group.

First, the biomolecule group which exists in the biomolecule group subset selected by the biomolecule group subset selection part 12 is obtained (step S1301B). Subsequently, the gene variation group mapped to each biomolecule of the selected biomolecule group and the gene variation scores being the first evaluation scores of the gene variation group are obtained (step S1302B). When the biomolecule mapping part 11 does not give the first evaluation score to each gene variation, the processing according to step S1302A in the above-described first method is conducted.

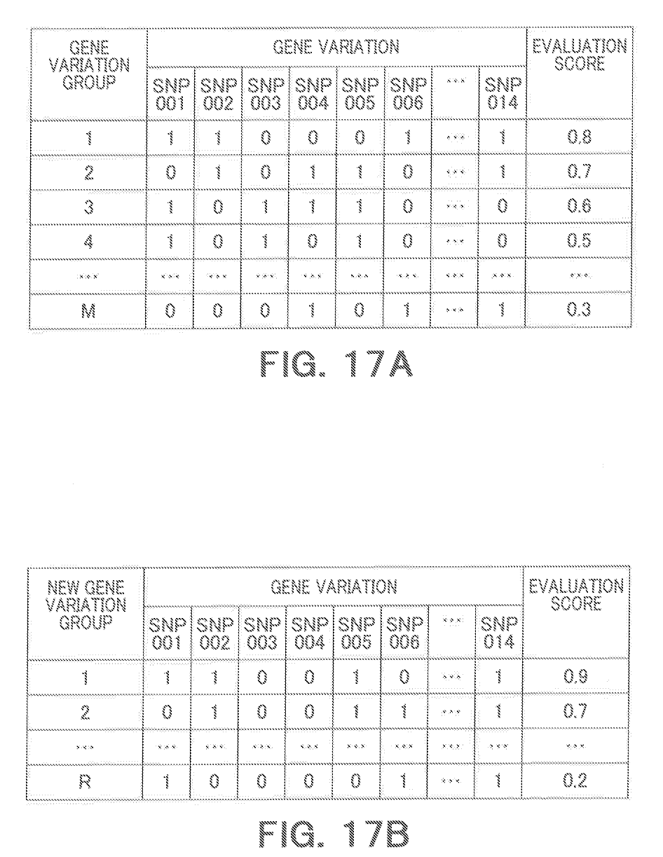

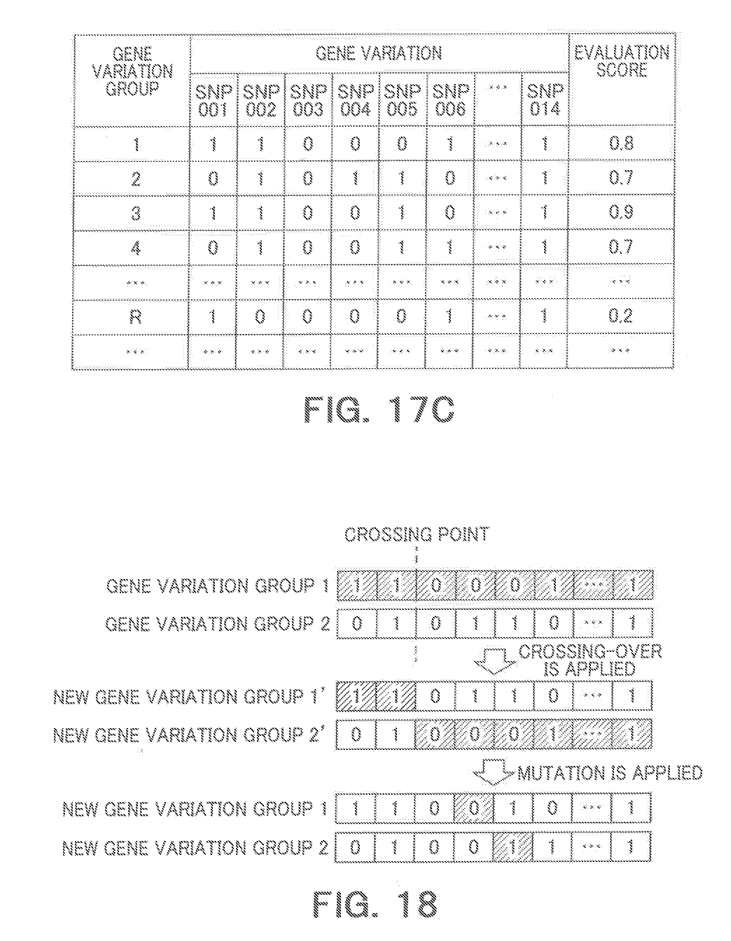

Next, the gene variations are randomly selected from the gene variation group mapped by the biomolecule mapping part 11 to the biomolecules to generate a set of M pieces of gene variation groups, and the evaluation part 14 is used to calculate the evaluation scores of the respective gene variation groups (step S1303B). FIG. 17A is a diagram illustrating one example of the generated gene variation groups and the second evaluation scores of the gene variation groups. Hereinafter, in FIG. 17A to FIG. 17C, and FIG. 18, “1” in the Table indicates that the gene variation is selected, and “0” indicates that the gene variation is not selected. In the example of FIG. 17A, 14 gene variations of SNP001 to SNP014 are selected as the gene variations, and one or a plurality of gene variations are selected from these 14 gene variations to generate the gene variation groups. Further, the second evaluation scores are calculated with respect to the generated gene variation groups. Note that as the gene variation groups to be initially generated, it is also possible to generate the gene variation groups based on the first evaluation scores in a manner such that the gene variation whose first evaluation score with respect to each biomolecule is equal to or larger than the predetermined threshold value is selected, and the other gene variations are not selected.

Next, it is judged whether or not a termination condition is satisfied (step S1304B). As the termination condition, there can be cited, for example, a condition such that the processing is performed the number of times of iteration which is previously set, or there is no change in the second evaluation score of the best gene variation group during the continuous iteration. When the termination condition is satisfied (step S1304B: Yes), the best gene variation group and the best evaluation score are output (step S1307B), and the processing is terminated. The best gene variation group is the second gene variation group being the typical gene variation group.

On the other hand, when the termination condition is not satisfied (step S1304B: No), concrete processing of genetic algorithm is conducted. Specifically, processing of selection, crossing-over, and mutation is repeatedly applied R/2 times to the generated set of the gene variations, to generate R pieces of new gene variation groups, and the evaluation part 14 is used to calculate the respective second evaluation scores of the generated gene variation groups (step S1307B).

FIG. 18 illustrates one example of processing in each step of the genetic algorithm in the present method. First, a gene variation group 1 and a gene variation group 2 are selected. Regarding the gene variation groups 1 and 2, a crossing point is set between a second gene variation and a third gene variation, and the gene variation group 1 and the gene variation group 2 are crossed over at the crossing point. As a result of this, new gene variation groups 1′ and 2′ are generated. The mutation is applied to these new gene variation groups 1′ and 2′. For example, a fourth gene variation in the gene variation group 1′ is mutated to be inverted, and a fifth gene variation in the gene variation group 2′ is also mutated to be inverted, in a similar manner. Consequently, new gene variation groups 1 and 2 are generated. FIG. 17B is a diagram illustrating a result of repeatedly conducting the processing above R/2 times to generate R pieces of new gene variation groups from the selected gene variation group 1 and gene variation group 2. Note that similarly to the above-described application of genetic algorithm, the number of crossing point is not limited to one, and further, the number of mutations applied to each gene variation group is not limited to two.

Referring back to FIG. 16, next, elite selection is performed on the M pieces of gene variation groups and the R pieces of new gene variation groups generated through the genetic algorithm, to thereby select M pieces of gene variation groups (step S1306B). By performing the selection as described above, the gene variation groups to be used for the next Iteration are selected. FIG. 17C is a diagram illustrating one example of the gene variation groups after the selection. As described above, by performing the elite selection on the original gene variation groups and the newly generated gene variation groups, the M pieces of gene variation groups are selected. For example, M-R pieces of gene variation groups are selected in descending order of the evaluation scores from the original gene variation groups, and to the selected gene variation groups, the newly generated R pieces of gene variation groups are added, to thereby select the M pieces of gene variation groups in total. For example, M equals to 1000, and R equals to 998.

As described above, the gene variation group selection part 13 selects the second gene variation groups as in the first method or the second method.

When the gene variation groups are selected, the evaluation part 14 calculates the second evaluation scores of the respective second gene variation groups. The second evaluation scores are calculated from the p value, the false discovery rate, and the F-measure as described above, or accuracy, an area under ROC curve (AUG: Area Under the Curve) or the like, for example. The biomarker candidate search is based on a feature selection or a classification problem, so that it is possible to use a feature selection or a performance evaluation function of classification in a machine learning field. Further, it is also possible that a plurality of evaluation values of these are calculated, and one evaluation score is further calculated from the calculated evaluation values. As one example, the evaluation score is determined through the following expression.

$$Evaluation score = {\sum }_{i = 0}^{k} {w}_{i} \times {f}_{i} ( evaluation {score}_{i} ) \qquad ( 1 )$$

Here, wᵢ∈[0, 1] indicates a weight of the previously set evaluation score i, and fᵢ (evaluation score i) indicates a function of converting or normalizing the evaluation score. For example, when the evaluation score i corresponds to the false discovery rate (FDR), the expression of fᵢ (evaluation score i)=1−FDR is satisfied. For example, If the p value, the false discovery rate (FDR), and the F-measure (F) of the gene variation group are p=1.4×10⁻³⁰, FDR=0.07, and F=0.70, and weights thereof are 0.2, 0.3, and 0.5, respectively, the conversion and the normalization of the p value and the false discovery rate are performed as p (conversion)=1−p, and FDR (conversion)=1−FDR. Next, the second evaluation score is determined as the evaluation score=0.2×(1−p)+0.3×(1−FDR)+0.5×F=0.829.

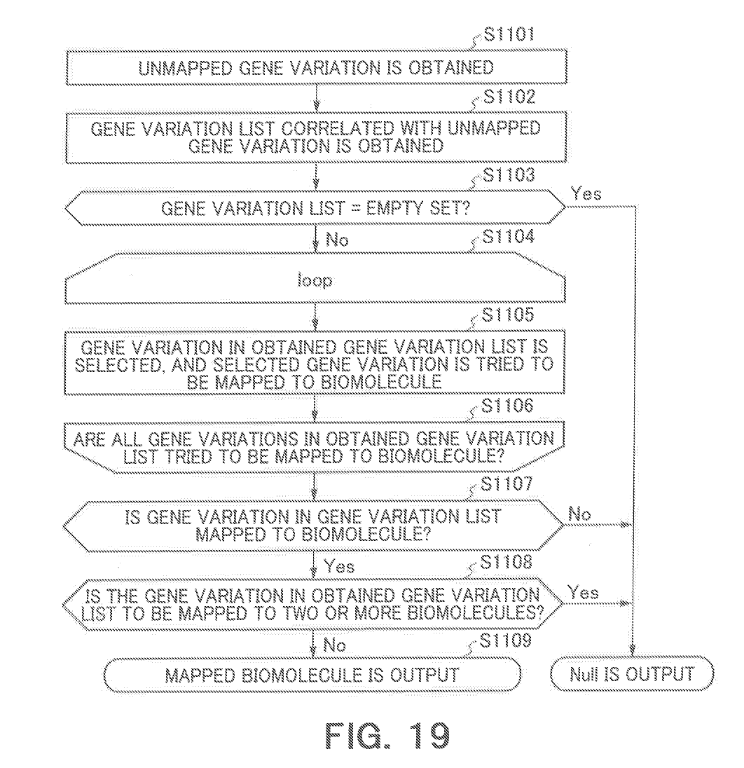

FIG. 19 is a flow chart Illustrating a flow of processing In which the biomolecule mapping part 11 performs mapping of an unmapped gene variation to a biomolecule by using the gene variation correlation data and the gene variation mapping data. First, the unmapped gene variation is obtained (step S1101).

Next, a gene variation group (gene variation list) having correlation with the unmapped gene variation is obtained (step S1102). Next, it is judged whether or not a set of the gene variation list is an empty set (step S1103). When the set of the gene variation list is the empty set (step S1103: Yes), Null is output, and the processing is terminated (step S1110). Here, NULL means that the gene variation is not mapped to the biomolecule. When there is a gene variation which is not mapped to the biomolecule, the gene variation group selection part 13 performs, when selecting the second gene variation group, the processing of selection without setting the gene variation as a target of the processing.

When the obtained gene variation list is not the empty set (step S1103: No), the processing proceeds to one in which the obtained gene variation is mapped to the biomolecule (step S1104). For example, the iteration variable is set to i, and starting from i=1, i is incremented every time the iteration processing is performed, thereby repeating the processing of step S1105 until when i becomes equal to the number of gene variations included in the obtained gene variation list.

Regarding contents of the processing, one gene variation in the obtained gene variation list is selected, and it is tried whether or not it is possible to map the selected gene variation to the biomolecule (step S1105). This mapping between the gene variation in the obtained gene variation list and the biomolecule, is performed based on the gene variation mapping data in the gene variation mapping database 5. Further, this processing is iterated until when the mapping of ail gene variations in the obtained gene variation list to the biomolecule is tried (step S1106). When the iteration variable i is used, it is first judged, in step S1106, whether or not i is less than the number of gene variations in the obtained gene variation list, and when i is less than the number of gene variations, i is incremented, and the processing returns to step S1105. When i is the same number as the number of gene variations in the obtained gene variation list, the processing exits from the loop and proceeds to the next step.

Next, it is checked whether or not the gene variation in the gene variation list is mapped to the biomolecule (step S1107). When none of the gene variation in the gene variation list is mapped to the biomolecule (step S1107: No), Null is output, and the processing is terminated. This is for preventing the gene variation from being mapped to the biomolecule.

On the other hand, when any gene variation in the gene variation list is mapped to the biomolecule (step S1107: Yes), it is checked whether or not the gene variation in the obtained gene variation list is mapped to two or more biomolecules (step S1108). When the gene variation in the obtained gene variation list is not mapped to the two or more biomolecules (step S1108: No), the biomolecule to which the gene variation in the obtained gene variation list is mapped, is output as the biomolecule to which the gene variation is mapped (step S1109), and the processing is terminated. For example, in a case of performing mapping between the biomolecule and the gene variation illustrated in FIG. 8, it is assumed that there is a gene variation SNP015 which has correlation with SNP003 and SNP004, and which is not mapped to a biomolecule. In this case, the biomolecule G1 to which SNP003 is mapped is output as the biomolecule to which SNP015 is mapped.

On the other hand, when the gene variation in the obtained gene variation list is mapped to the two or more biomolecules (step S1108: Yes), Null is output (step S1110), and the processing is terminated. In the above-described example, it is assumed that there is a gene variation SNP016 which has correlation with SNP010 and SNP013, and which is not mapped to a biomolecule. In this case, it is not possible to judge whether SNP016 is mapped to the biomolecule G3 or the biomolecule G4. In order not to perform erroneous mapping in such a case, when the mapping to two or more biomolecules is performed, Null is output. Note that even in the case where SNP016 has correlation with SNP010 and SNP013, if SNP016 has strong correlation with one of SNP010 and SNP013, and has weak correlation with the other, it is also possible to perform output indicating that SNP016 is mapped to the biomolecule to which the gene variation having strong correlation with SNP016 is mapped.

As described above, with the use of the biomarker search device according to the present embodiment, based on the respective databases such as the gene variation database 2, the biomolecule group database 3, the gene variation correlation database 4, and the gene variation mapping database 5, the biomolecule groups are combined, the gene variations in the combination are specified, and the evaluation value of the combination is calculated, which enables to search the biomarker with high reliability based on the genotype data of the case group afflicted with a specific disease and the control group.

### Second Embodiment

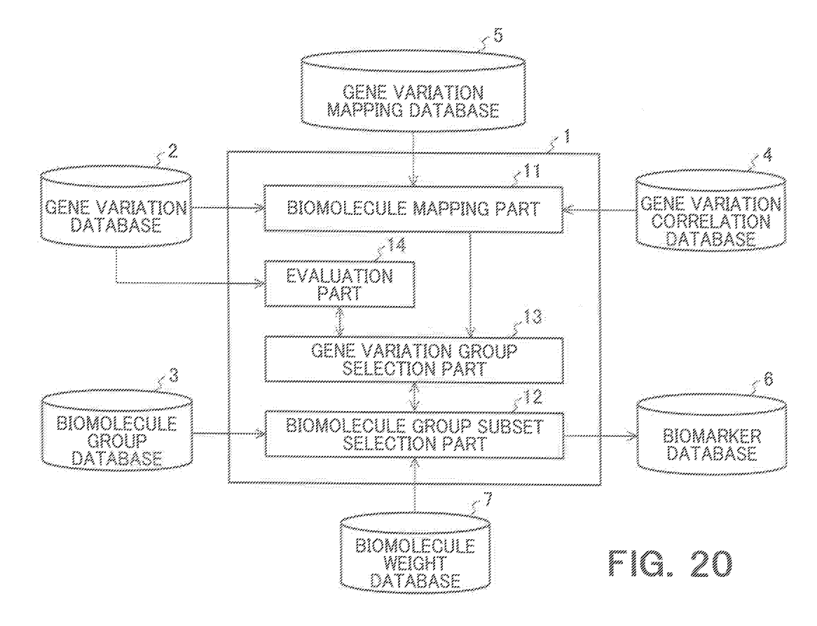

FIG. 20 is a block diagram illustrating a functional configuration of a biomarker search device according to a second embodiment. As illustrated in FIG. 20, the biomarker search device according to the present embodiment is configured by further including a biomolecule weight database 7 in the biomarker search device according to the first embodiment described above. The biomolecule weight database 7 is a database holding biomolecule weight data (first weight data) being weight data of the biomolecule, In a plurality of forms. For example, the biomolecule weight data holds data of a biomolecule associated with a specific disease or quantitative trait, which is known In a biological research or a clinical test. For example, the biomolecule weight data includes weight data based on information of experimental result and the like, indicating that a case group afflicted with a specific disease has a high probability of generating a specific biomolecule.

In the present embodiment when the biomolecule group subset selection part 12 selects the biomolecule group from the biomolecule group data in the biomolecule group database 3, it is set to perform selection by increasing priority of the biomolecule group in which the biomolecule in the biomolecule weight data exists. In this processing, when there is biomolecule weight data regarding a plurality of biomolecules in one biomolecule group, the priority of the biomolecule group is represented by the following expression.

$$Priority = \frac{{\sum }_{\text{?}}^{\text{?}} {w}_{i}}{l} \\ \text{?} \text{indicates text missing or illegible when filed} \qquad ( 2 )$$

Here, i is a number of biomolecules in the biomolecule group, and wᵢ indicates a weight of an i-th biomolecule. When the i-th biomolecule is included in the biomolecule weight data, Wᵢ corresponds to a weight of the biomolecule, but, when the biomolecule is not included in the biomolecule weight data, wᵢ becomes 0. Further, regarding the weighting of the biomolecule, it is also possible to design such that the weighting is performed on each biomolecule included in the biomolecule weight data, or the weight of the biomolecule included in the biomolecule weight data is set to 1.0 and the weight of the biomolecule which is not included in the biomolecule weight data is set to 0.0, for example. For example, when the latter weighting is performed in FIG. 3, and G1 and G4 are included in the biomolecule weight data, the priority of the biomolecule group BG1 becomes 0.33 (=(1.0+0.0+0.0)/3), the priority of BG2 becomes 0.67 (=(1.0+0.0+1.0)/3), the priority of BG3 becomes 0.67 (=(1.0+0.0+0.0+1.0)/3), and the priority of BG4 becomes 0.50 (=(1.0+0.0+0.0+1.0)/4). Specifically, the biomolecule group subset selection part 12 preferentially selects the biomolecule group in the order of BG2=BG3>BG4>BG1,

For example, in the case of using the second method regarding the biomolecule group subset selection described above, when the number of common biomolecules of the two biomolecule groups are the same at the time of selecting the biomolecule group having the largest number of common biomolecules in step S1206B in FIG. 11, the biomolecule group with higher priority may be selected.

In another example, in the case of using the third method regarding the biomolecule group subset selection described above, when selecting the biomolecule group in step S1202C in FIG. 12, it is also possible to design such that the biomolecule group is not randomly selected, but is selected In a stochastic manner by using the priorities.

As described above, according to the present embodiment, when the biomolecule group subset selection part 12 selects the biomolecule group subset, it performs the selection of the biomolecule group in accordance with the priority of the biomolecule group based on the biomolecule, so that when searching the biomarker regarding a specific disease, it becomes possible to search the biomarker with higher accuracy.

### Third Embodiment

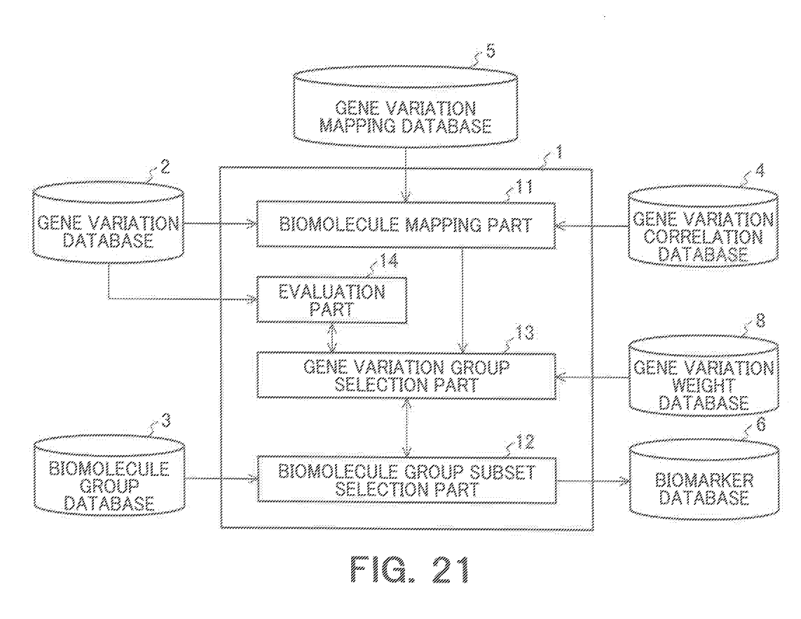

FIG. 21 is a block diagram illustrating a functional configuration of a biomarker search device according to a third embodiment. As illustrated in FIG. 21, the biomarker search device according to the present embodiment is configured by further including a gene variation weight database in the biomarker search device according to the first embodiment described above. The gene variation weight database 8 is a database which holds information of the gene variations, which is important regarding a specific disease, and gene variation weight data (second weight data) being weight data by which those gene variations are preferentially selected. It is also possible to design such that the gene variation weight data holds gene variations associated with a specific disease or quantitative trait, which is known in a biological research or a clinical test. For example, the gene variation weight data includes weight data based on information and the like such that a case group afflicted with a specific disease has a high probability of possessing a specific gene variation (SNP).

The gene variation group selection part 13 uses the gene variation weight data at the time of selecting the second gene variation group. These weights are used to determine priority of a certain gene variation group through the following expression.

$$Priority = \frac{{\sum }_{\text{?}}^{q} {w}_{i}}{q} \\ \text{?} \text{indicates text missing or illegible when filed} \qquad ( 3 )$$

Here, q is a number of gene variations in the gene variation group, and wᵢ indicates a weight of an i-th gene variation. In a similar manner to the above-described second embodiment, when the i-th gene variation is included in the gene variation weight data, Wᵢ corresponds to a weight of the gene variation, but, when the gene variation is not included in the gene variation weight data, wᵢ becomes 0. Further, regarding the weighting of the gene variation, it is also possible to design such that the weighting is performed on each gene variation included in the gene variation weight data, or the weight of the gene variation included in the gene variation weight data is set to 1.0 and the weight of the gene variation which is not included in the gene variation weight data is set to 0.0, for example.

For example, in the case of using the first method regarding the gene variation group selection described above, when the evaluation score and the best evaluation score are the same in step S1309A in FIG. 15, it is also possible to calculate the priorities of the selected gene variation group and the best gene variation group through the aforementioned expression, and to perform judgment in step S1309A based on the priorities. Specifically, it is also possible to design such that when the priority of the selected gene variation group is higher than the priority of the best gene variation group, the processing proceeds to step S1310A, and when the priority of the selected gene variation group is equal to or less than the priority of the best gene variation group, the processing proceeds to step S1312A.

In another example, in the case of using the second method regarding the gene variation group selection described above, when selecting the gene variations from the list of gene variations mapped to the biomolecules in step S1303B in FIG. 16, it is also possible to design such that the gene variations are not randomly selected, but are selected in a stochastic manner by using these priorities.

As described above, according to the present embodiment, when the gene variation selection part 13 selects the gene variation group, it performs the selection of the gene variation group in accordance with the priority of the gene variation indicating the gene variation having high correlation with a specific disease, so that when searching the biomarker regarding the specific disease, it becomes possible to search the biomarker with higher accuracy,

### Fourth Embodiment

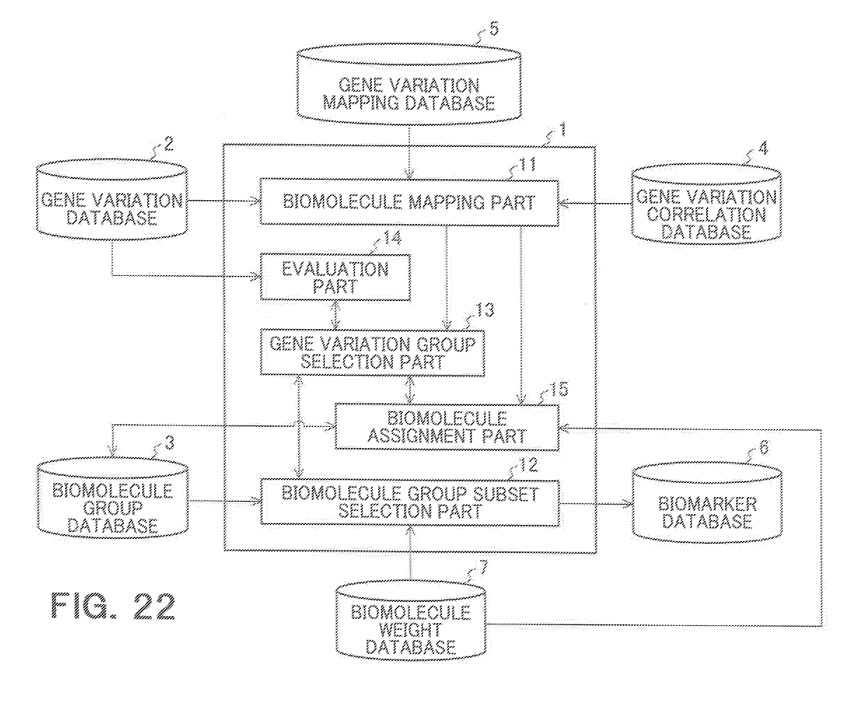

FIG. 22 is a block diagram illustrating a functional configuration of a biomarker search device according to a fourth embodiment. As illustrated in FIG. 22, the biomarker search device according to the present embodiment is configured by further including, in the biomarker search device according to the first embodiment described above, a biomolecule weight database 7, and a biomolecule assignment part 15 in the biomarker search unit 1.

The biomolecule database 7 is similar to the biomolecule weight database 7 according to the second embodiment described above.

The biomolecule assignment part 15 performs, when a certain biomolecule is not mapped to the biomolecule group stored and held in the biomolecule group database 3, mapping of the biomolecule to any biomolecule group. Details will be described hereinafter.

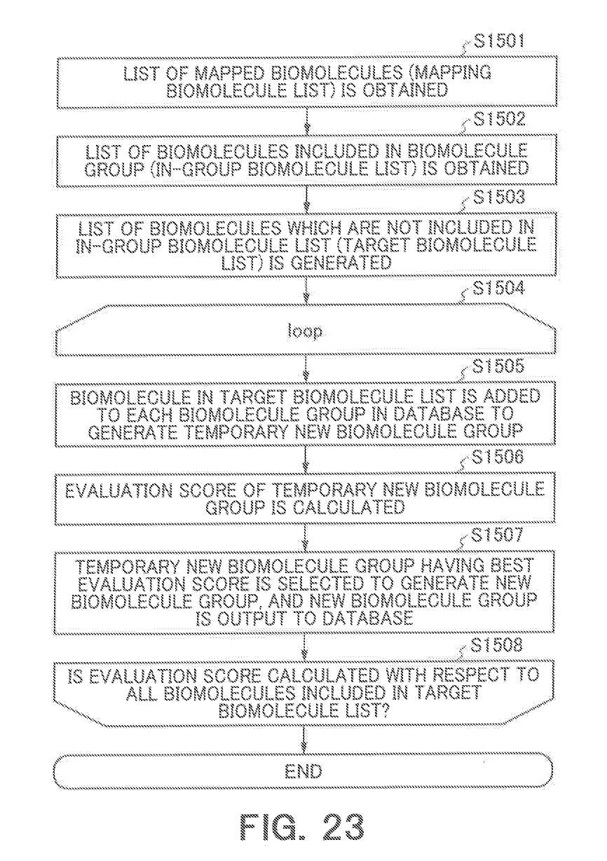

FIG. 23 is a flow chart illustrating a flow of processing of the biomolecule assignment part 15. First, a list of mapped biomolecules (mapping biomolecule list) is obtained from the biomolecule mapping part 11 (step S1501). Next, from the biomolecule group database 3, a list of biomolecules included in the biomolecule group (in-group biomolecule list) is obtained (step S1502). Next, by comparing these mapping biomolecule list and in-group biomolecule list, a list of biomolecules which are not included in the in-group biomolecule list (target biomolecule list) is generated (step S1503).

Next, the processing proceeds to loop processing (step S1504). When the iteration variable i is used, i is initialized to 1, for example, the processing is performed while incrementing i, and the following processing is repeated until i takes a predetermined value.

First, to each biomolecule group Included in the biomolecule group database 3, an i-th biomolecule in the target biomolecule list is added, to thereby generate a temporary new biomolecule group (step S1505). Next, an evaluation score of the generated temporary new biomolecule group is calculated (step S1506). This evaluation score is calculated by using the gene variation group selection part 13 and the evaluation part 14. The evaluation score uses, for example, the second evaluation score, namely, the indices such as the p value, the false discovery rate, and the F-measure, similarly to the above-described embodiments.

Next, the temporary new biomolecule group having the best calculated evaluation score is selected to generate a new biomolecule group, and the new biomolecule group is output to the biomolecule group database 3 (step S1507). Subsequently, it is judged whether or not the evaluation score is calculated with respect to all biomolecules included in the target biomolecule list (step S1508). For example, when the iteration variable i is used, it is judged whether or not i is smaller than the number of biomolecules in the target biomolecule list, and when i is smaller than the number of biomolecules, i is incremented and the processing returns to step S1505. On the other hand, when i is equal to or larger than the number of biomolecules in the target biomolecule list, the processing is terminated.

Further, in the present embodiment, it is also possible to use the biomolecule weight database 7 described in the second embodiment, and perform the processing by using the biomolecule weight data. For example, when generating the temporary new biomolecule group in step S1505, it is also possible to design such that the priorities are calculated, and the temporary new biomolecule group is generated based on the priorities.

As described above, according to the present embodiment, it becomes possible that the biomolecule which is not assigned to the biomolecule group is assigned to the biomolecule group, to thereby newly generate the biomolecule group data, which widens the width of biomarker search. Consequently, it becomes possible to enlarge the range of biomarker search, and to perform the biomarker search with better accuracy.

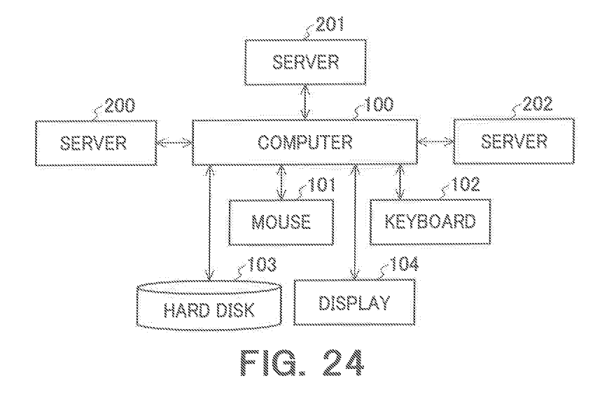

All of the embodiments described above are carried out through a hardware configuration as illustrated in FIG. 24, for example. Specifically, the biomarker search unit 1 is constructed in a computer 100, and the biomarker search unit 1 receives instructions from a user by using a mouse 101 and a keyboard 102 as interfaces. In a hard disk 103, a program which activates the computer 100 and activates the biomarker search unit 1 may be included, and a database which stores and holds input/output data of the biomarker search unit 1 may be constructed. A display 104 is provided as a visual Interface of the biomarker search unit 1. Servers 200, 201, and 202 are various databases such as the gene variation database 2 and the biomolecule group database 3, for example, and further, it is also possible to provide tools for obtaining desired data from these databases. As another example, the various databases may also be constructed in the hard disk 103 connected to the computer 100.

At least a part of the disease-associated biomarker search device and the disease-associated biomarker search system described in the aforementioned embodiments may also be configured by hardware or software. When configuring the above using the software, it is also possible to design such that a program realizing at least a part of functions of the biomarker search device and the biomarker search system is housed in a recording medium such as a flexible disk or a CD-ROM, and a computer is made to read and execute the program. A storage medium is not limited to a detachable one such as a magnetic disk or an optical disk, and it may also be a fixed-type storage medium such as a hard disk device or a memory.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A biomarker search device, comprising:
a gene variation group selector which generates a plurality of combinations by combining a plurality of biomolecule groups which hold interaction information between a plurality of biomolecules, specifies a plurality of gene variations associated with a plurality of biomolecules included in the combinations, based on gene variation mapping data indicating biomolecules associated with a plurality of gene variations, respectively, calculates first evaluation values of the specified plurality of gene variations with respect to the biomolecules associated with the specified plurality of gene variations, respectively, based on influence data representing a degree of influence given by the gene variations to the biomolecules, and selects a typical gene variation group from the specified plurality of gene variations, based on the first evaluation values; and
an evaluator which calculates a second evaluation value with respect to the typical gene variation group based on gene variation data which holds genotype data of a case group afflicted with a specific disease and genotype data of a control group, and selects at least one of the typical gene variation group from a plurality of the typical gene variation groups based on a plurality of the second evaluation values.

2. The biomarker search device according to claim 1, further comprising
a biomolecule group subset selector which generates a plurality of combinations by combining the plurality of biomolecule groups holding the interaction information between the plurality of biomolecules, and selects at least one of the combination from the plurality of combinations based on the second evaluation values.

3, The biomarker search device according to claim 2, wherein
the biomolecule group subset selector calculates the second evaluation values of the plurality of biomolecule groups, selects one biomolecule group whose calculated second evaluation value is high, thereafter, additionally selects a biomolecule group other than the selected biomolecule group and combines the groups to generate the combination, and selects the combination based on the second evaluation value of the combination.

4. The biomarker search device according to claim 2, wherein
the biomolecule group subset selector calculates the second evaluation values of the plurality of biomolecule groups, selects one biomolecule group whose calculated second evaluation value is high, thereafter; additionally selects, out of the biomolecule groups except for the selected biomolecule group, the biomolecule group whose number of biomolecules common to the biomolecules included in the selected biomolecule group is larger than that of the other biomolecule groups, and combines the groups to generate the combination, and selects the combination based on the second evaluation value of the combination.

5. The biomarker search device according to claim 2, wherein
the biomolecule group subset selector combines the plurality of biomolecule groups to generate the plurality of combinations, calculates the second evaluation values of the plurality of combinations, selects a plurality of combinations whose calculated second evaluation values are high, and selects the combination based on a genetic algorithm using the second evaluation value applied to the selected plurality of combinations.

6. The biomarker search device according to claim 1, wherein
when specifying the typical gene variation group, the gene variation group selector further evaluates the typical gene variation group by using the second evaluation value with respect to the typical gene variation group, to specify the typical gene variation group.

7. The biomarker search device according to claim 6, wherein
the gene variation group selector specifies, out of the typical gene variation groups of the combinations, one of the typical gene variation group whose second evaluation value is high, and selects the typical gene variation group based on a threshold method using the second evaluation value applied to the specified typical gene variation group.

8. The biomarker search device according to claim 6, wherein
the gene variation group selector specifies, out of the typical gene variation groups of the combinations, a plurality of the typical gene variation groups whose second evaluation values are high, and selects the typical gene variation group based on a genetic algorithm using the second evaluation value applied to the specified plurality of typical gene variation groups.

9. The biomarker search device according to claim 2, further comprising
a biomolecule mapper which maps a gene variation which is not mapped to the biomolecule to the biomolecule, based on gene variation correlation data holding correlation information between the plurality of gene variations, and the gene variation mapping data.

10. The biomarker search device according to claim 9, wherein:
the gene variation data comprises base sequence data of the case group and base sequence data of the control group; and
the biomolecule mapper generates the genotype data of the case group and the genotype data of the control group from the base sequence data of the case group and the base sequence data of the control group.

11. The biomarker search device according to claim 9, wherein:
the gene variation data comprises base sequence data of the case group and base sequence data of the control group; and
the biomolecule group subset selector generates the genotype data of the case group and the genotype data of the control group from the base sequence data of the case group and the base sequence data of the control group.

12. The biomarker search device according to claim 2, wherein
the biomolecule group subset selector selects the combination from the biomolecule groups based on first weight data being priority information of the biomolecule to which the gene variation is mapped.

13. The biomarker search device according to claim 2, wherein
the gene variation group selector selects the typical gene variation group from the gene variations mapped to the biomolecules in the combination selected by the biomolecule group subset selector, based on second weight data being priority information of the gene variation.

14. The biomarker search device according to claim 1, further comprising
a biomolecule assignor which assigns a biomolecule which does not exist in the data of the biomolecule groups, out of the biomolecules to which the gene variations are mapped, to any of the biomolecule group in the biomolecule groups.

15. The biomarker search device according to claim 1, wherein the evaluator calculates a plurality of types of evaluation values with respect to one of the typical gene variation group, and performs normalization and weighting addition on the plurality of types of evaluation values, to calculate the second evaluation value.

16. A biomarker search method, comprising:
generating a plurality of combinations by combining a plurality of biomolecule groups which hold Interaction Information between a plurality of biomolecules;
specifying a plurality of gene variations associated with a plurality of biomolecules included in the combinations, based on gene variation mapping data indicating biomolecules associated with a plurality of gene variations, respectively;
calculating first evaluation values of the specified plurality of gene variations with respect to the biomolecules associated with the specified plurality of gene variations, respectively, based on influence data representing a degree of influence given by the gene variations to the biomolecules;
specifying a typical gene variation group from the specified plurality of gene variations, based on the first evaluation values;
calculating a second evaluation value with respect to the typical gene variation group based on gene variation data which holds genotype data of a case group afflicted with a specific disease and genotype data of a control group; and
selecting at least one of the typical gene variation group from a plurality of the typical gene variation groups based on a plurality of the second evaluation values.

17. A non-transitory computer readable medium having a computer program stored therein which when executed by a computer, causes the computer to perform processing of steps comprising:
generating a plurality of combinations by combining a plurality of biomolecule groups which hold interaction information between a plurality of biomolecules;
specifying a plurality of gene variations associated with a plurality of biomolecules included in the combinations, based on gene variation mapping data indicating biomolecules associated with a plurality of gene variations, respectively;
calculating first evaluation values of the specified plurality of gene variations with respect to the biomolecules associated with the specified plurality of gene variations, respectively, based on Influence data representing a degree of influence given by the gene variations to the biomolecules;
specifying a typical gene variation group from the specified plurality of gene variations, based on the first evaluation values;
calculating a second evaluation value with respect to the typical gene variation group based on gene variation data which holds genotype data of a case group afflicted with a specific disease and genotype data of a control group; and
selecting at least one of the typical gene variation group from a plurality of the typical gene variation groups based on a plurality of the second evaluation values.
